(19) United States
(12) Patent Application Publication
(10) Pub. No.: US 2026/0310988 A1
(43) Pub. Date: Oct. 8, 2026

(54) MECHANISM FOR DETECTING DATA AND MODEL POISONING ATTACK IN FEDERATED LEARNING

(71) Applicant: Nokia Solutions and Networks Oy, Espoo (FI)

(72) Inventors: Chaitanya AGGARWAL, Munich (DE); Divya G NAIR, Bangalore (IN); Jafar MOHAMMADI, Munich (DE)

(21) Appl. No.: 19/491,455

(22) PCT Filed: Jun. 19, 2024
(86) PCT No.: PCT/IB2024/056005

§ 371 Date: Dec. 9, 2025

(30) Foreign Application Priority Data
Jun. 30, 2023 (IN) 202311044131

(51) Int. Cl. G06N 3/098; G06N 3/0455; H04L 9/40

(52) U.S. Cl. CPC G06N 3/098; G06N 3/0455; H04L 63/1425

(57) ABSTRACT

An apparatus comprising at least one processor, and at least one memory for storing instructions that, when executed by the at least one processor, cause the apparatus at least: to obtain local model update data from each of a plurality of clients of a federated learning, FL, procedure, to determine whether at least one of the plurality of clients is a suspicious client showing a harmful behavior in the FL procedure by conducting a test with a reference dataset, if at least one suspicious client is determined, to execute an identification procedure for identifying at least one malicious client, and to perform a global model update process considering a result of a malicious client identification.

### FIELD

Examples of embodiments described herein relate to apparatuses, methods, systems, computer programs, computer program products and (non-transitory) computer-readable media usable for detecting attacks on federated learning (FL) systems. In particular, some examples of embodiments relate to apparatuses, methods, systems, computer programs, computer program products and (non-transitory) computer-readable media usable for a mechanism which enables to detect attacks, such as data and model poisoning attacks, on an FL system, in particular an FL based autoencoder, to identify a source of the attack, such as a malicious FL client, and to take countermeasures against this attack.

### BACKGROUND

The following description of background may include insights, discoveries, understandings or disclosures, or associations, together with disclosures that are not already known, but rather provided herein by the disclosure as one or more examples of embodiments. Some of examples of embodiments may be specifically pointed out below, whereas other of such contributions will be apparent from the related context.

The following meanings for the abbreviations used herein apply:
3GPP 3^{rd} Generation Partnership Project
4G/5G/6G fourth/fifth/sixth generation
5GC 5^{th} Generation core network
AI artificial intelligence
AIML artificial intelligence-machine learning
DoS denial of service attack
DDoS distributed denial of service attack
eNB E-UTRAN Node B
FL federated learning
gNB next generation node B
ID identification, identifier
IID independent and identically distributed
LTE Long Term Evolution
LTE-A LTE Advanced
ML machine learning
MSE mean square error
NF network function
NG next generation
NW network, network side
RAN radio access network
UE user equipment
WLAN wireless local area network

### SUMMARY

According to an example of an embodiment, there is provided, for example, an apparatus comprising at least one processor, and at least one memory for storing instructions that, when executed by the at least one processor, cause the apparatus at least: to obtain local model update data from each of a plurality of clients of a federated learning, FL, procedure, to determine whether at least one of the plurality of clients is a suspicious client showing a harmful behavior in the FL procedure by conducting a test with a reference dataset, if at least one suspicious client is determined, to execute an identification procedure for identifying at least one malicious client, and to perform a global model update process considering a result of a malicious client identification.

Furthermore, according to an example of an embodiment, there is provided, for example, a method comprising obtaining local model update data from each of a plurality of clients of a federated learning, FL, procedure, determining whether at least one of the plurality of clients is a suspicious client showing a harmful behavior in the FL procedure by conducting a test with a reference dataset, if at least one suspicious client is determined, executing an identification procedure for identifying at least one malicious client, and performing a global model update process considering a result of a malicious client identification.

According to further refinements, these examples may include one or more of the following features:
model data may be based on using, at each client, an autoencoder comprising a predetermined number of encoders and a predetermined number of decoders;
it may be determined whether at least one of the plurality of clients is a suspicious client showing a harmful behavior in the FL procedure by tracking changes in model related parameters of each of the plurality of clients, if at least one suspicious client is determined, a test may be conducted for each suspicious client with the reference dataset and to determine on the basis of the test whether at least one of the suspicious clients is a confirmed suspicious client, if at least one confirmed suspicious client is determined, for identifying the at least one malicious client, a statistic check for each confirmed suspicious client may be executed and it may be determined on the basis of the statistic check whether at least one of the confirmed suspicious clients is a malicious client;
for determining whether at least one of the plurality of clients is a suspicious client, local model parameters of each of the plurality of clients may be clustered, a cluster centroid for each of the plurality of clients may be computed, it may be detected for each of the plurality of clients whether a change of the cluster centroid is greater than a first threshold, and in case the change of the cluster centroid is greater than the first threshold, the corresponding client may be added to a candidate list of suspicious clients;
for determining whether a suspicious client is a confirmed suspicious client, the model obtained from the suspicious client may run on the reference dataset, a performance matrix on the basis of a result of running the obtained model may be obtained, the obtained performance matrix may be compared with a previously obtained performance matrix of a previous iteration update for determining whether a change in the performance matrix is greater than a second threshold, and in case the change in the performance matrix is greater than the second threshold, the corresponding suspicious client may be added to a candidate list of confirmed suspicious clients;
in case the change in the performance matrix is not greater than the second threshold, the corresponding suspicious client may be removed from the candidate list of suspicious clients;
for determining whether a confirmed suspicious client is a malicious client, a mean of a processing layer of the model obtained from the confirmed suspicious client may be computed, the computed mean may be compared with a mean of a corresponding processing layer of another client for determining whether a deviation between the means is greater than a third threshold, and in case the deviation is greater than the third threshold, the corresponding client may be identified as a malicious client;
an Euclidian distance between the computed mean of the confirmed suspicious client and the mean of the corresponding processing layer of the other client may be computed, and it may be determined whether the computed Euclidian distance is greater than the third threshold for identifying whether the confirmed suspicious client is a malicious client;
the other client may be a predetermined client verified to be a normal client;
the processing layer may be the last encoded layer of an autoencoder used in the client to be considered;
each malicious client may be excluded from the FL procedure, and/or each client being identified as being malicious may be informed about the result of the identification;
it may be determined whether at least one of the plurality of clients is a suspicious client showing a harmful behavior in the FL procedure by conducting the test with the reference dataset on an aggregated model based on the obtained local model update data from each of a plurality of clients, a result of the test may be compared with a result of a previously conducted test of a previous global model using the reference dataset, if the comparison shows that at least one malicious client is present, for identifying the at least one malicious client, Euclidian distances of weight parameters of each local model and the global model may be determined, the determined Euclidian distances may be grouped in two groups on the basis of the value of the respective Euclidian distance, and clients may be identified as malicious clients on the basis of the result of the grouping;
for obtaining the aggregated model based on the obtained local model update data from each of a plurality of clients, a priority factor assigned to each of the plurality of clients may be considered;
when an iteration of the FL procedure for the aggregated model to be tested is n, a global model may be used for the test using the reference dataset of an (n−1)th iteration of the FL procedure;
determine, as the a result of the test, a number of false inferences of the test of the aggregated model and a number of false inferences of the previously conducted test of the previous global model may be determined using the reference dataset, a difference of the determined numbers of false inferences may be compared with a sixth threshold, if the comparison shows that the difference of the determined numbers of false inferences is greater than the sixth threshold, it may be decided that at least one malicious client is present;
if the comparison shows that the difference of the determined numbers of false inferences is smaller than or equal to the sixth threshold, the aggregated model may be used as a new updated global model;
the sixth threshold may be configurable by a user;
for identifying the at least one malicious client, Euclidian distances of weight parameters of each layer of the local model and each layer of the global model may be determined, wherein, when grouping the determined Euclidian distances in two groups, values of the respective Euclidian distance related to one of the layers of the local model and the global model or values of the respective Euclidian distance related to all layers of the local model and the global model may be considered;
the clients belonging to the group having the lower cardinality may be identified as being malicious clients;
when a malicious client is identified, a new aggregated model may be obtained based on the obtained local model update data from each of a plurality of clients excluding the malicious clients, the test with the reference dataset may be conducted on the new aggregated model, a result of the test on the new aggregated model may be compared with the result of the previously conducted test of the previous global model using the reference dataset, and it may be verified that no malicious client is present on the basis of the comparison;
when a malicious client is identified, each client being identified as being malicious may be informed about the result of the identification;
when performing the global model update process considering the result of a malicious client identification, model parameter input from the malicious client may be discarded and an updated model may be shared in the next iteration with the plurality of clients involved in the FL procedure excluding the malicious clients;
the determination of suspicious clients may be conducted in each iteration of the FL procedure.

According to an example of an embodiment, there is provided, for example, an apparatus comprising at least one processor, and at least one memory for storing instructions that, when executed by the at least one processor, cause the apparatus at least: to conduct a training procedure for a local model based on a global model received in a federated learning, FL, procedure, to compute a fourth threshold to be used in a test of the local model, to execute a local testing procedure for the local model using the computed fourth threshold, and to decide on sharing the local model with an FL server providing the global model, or to repeat the training procedure of the local model.

Furthermore, according to an example of an embodiment, there is provided, for example, a method comprising conducting a training procedure for a local model based on a global model received in a federated learning, FL, procedure, computing a fourth threshold to be used in a test of the local model, executing a local testing procedure for the local model using the computed fourth threshold, and deciding on sharing the local model with an FL server providing the global model, or repeating the training procedure of the local model.

According to further refinements, these examples may include one or more of the following features:
for computing the fourth threshold, a mean squared error may be computed in the local model by using a preset validation dataset, a mean and a standard deviation of the computed mean squared error may be calculated, it may be determined whether the calculated mean of the mean squared error is smaller than the standard deviation of the mean squared error by a fifth threshold or more, if the determination is affirmative, a first procedure for obtaining the fourth threshold may be used, or otherwise a second procedure for obtaining the fourth threshold may be used;
the first procedure for obtaining the fourth threshold may comprise a quantile thresholding mechanism, and the second procedure for obtaining the fourth threshold may comprise a calculation of the fourth threshold by adding the calculated mean of the mean squared error and the standard deviation of the mean squared error;
for computing the fourth threshold, a threshold data set including feature vectors may be inputted in the local model, the threshold data set comprising only benign samples, and to get a reconstructed data vector from the local model, a mean squared error may be computed on the basis of the threshold data set and the reconstructed data vector, a quantile value of the computed mean squared error may be computed, a mean and a standard deviation of the computed mean squared error may be calculated, it may be determined whether the quantile value of the mean squared error is greater than a value based on a sum of the calculated mean of the mean squared error and the standard deviation of the mean squared error, and if the determination is affirmative, the sum of the calculated mean of the mean squared error and the standard deviation of the mean squared error may be used as the fourth threshold, or otherwise the computed quantile value may be used as the fourth threshold;
the value based on a sum of the calculated mean of the mean squared error and the standard deviation of the mean squared error may be a sum of the calculated mean of the mean squared error and k times the standard deviation of the mean squared error, wherein k may be a natural number equal to or greater than 3.
when executing the local testing procedure for the local model using the computed fourth threshold, a reconstruction error for predetermined test data on the local model may be computed, it may be determined whether the computed reconstruction error is equal to or greater than the fourth threshold, and it may be decided whether a result of the local testing procedure is abnormal when the determination results in that the computed reconstruction error is equal to or greater than the fourth threshold;
a performance matrix may be computed for at least one of an accuracy, a precision, a recall and an F1 score of the local model;
the local model may use an autoencoder comprising a predetermined number of encoders and a predetermined number of decoders.

In addition, according to embodiments, there is provided, for example, a computer program product for a computer, including software code portions for performing the steps of the above defined methods, when said product is run on the computer. The computer program product may include a computer-readable medium on which said software code portions are stored. Furthermore, the computer program product may be directly loadable into the internal memory of the computer and/or transmittable via a network by means of: upload; download; and/or push procedures.

### BRIEF DESCRIPTION OF THE DRAWINGS

Some examples of disclosure related to embodiments are described below, by way of example only, with reference to the accompanying drawings, in which:

FIG. 1 shows a diagram illustrating an example for a setup of an FL procedure;

FIG. 2 shows a diagram illustrating an example of an autoencoder structure;

FIG. 3 shows an example of an algorithm for building an autoencoder in FL according to examples of embodiments;

FIG. 4 shows an example of an algorithm for detecting attack in FL according to examples of embodiments;

FIG. 5 shows a diagram illustrating examples of performance matrices considered in examples of embodiments;

FIG. 6 shows a flow chart of a processing conducted in an FL server according to some examples of embodiments;

FIG. 7 shows a flow chart of a processing conducted in an FL client according to some examples of embodiments;

FIG. 8 shows a diagram of a network element acting as an FL server according to some examples of embodiments;

FIG. 9 shows a diagram of a network element acting as an FL client according to some examples of embodiments;

FIG. 10 shows an example of an algorithm for computing an error threshold according to examples of embodiments;

FIG. 11 shows an example of an algorithm for detecting attack in FL according to examples of embodiments;

FIG. 12 shows an example of an algorithm for identifying a malicious client in FL according to examples of embodiments; and

FIG. 14 shows a diagram illustrating a result of a clustering according to examples of embodiments.

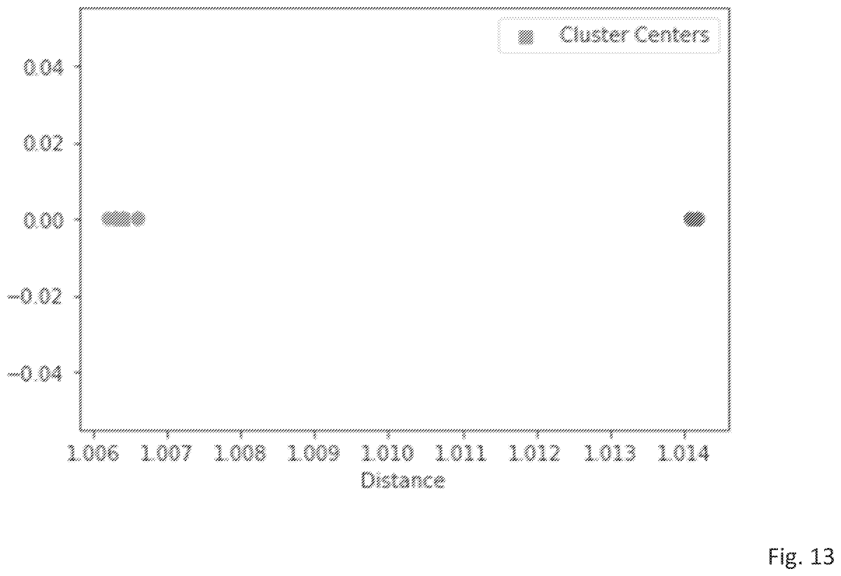

### DETAILED DESCRIPTION

In the last years, an increasing extension of communication networks, e.g. of wire based communication networks, such as the Integrated Services Digital Network (ISDN), Digital Subscriber Line (DSL), or wireless communication networks, such as the cdma2000 (code division multiple access) system, cellular 3^{rd} generation (3G) like the Universal Mobile Telecommunications System (UMTS), fourth generation (4G) communication networks or enhanced communication networks based e.g. on Long Term Evolution (LTE) or Long Term Evolution-Advanced (LTE-A), fifth generation (5G) communication networks, cellular 2^{nd} generation (2G) communication networks like the Global System for Mobile communications (GSM), the General Packet Radio System (GPRS), the Enhanced Data Rates for Global Evolution (EDGE), or other wireless communication system, such as the Wireless Local Area Network (WLAN), Bluetooth or Worldwide Interoperability for Microwave Access (WiMAX), took place all over the world. Various organizations, such as the European Telecommunications Standards Institute (ETSI), the 3^{rd} Generation Partnership Project (3GPP), Telecoms & Internet converged Services & Protocols for Advanced Networks (TISPAN), the International Telecommunication Union (ITU), 3^{rd} Generation Partnership Project 2 (3GPP2), Internet Engineering Task Force (IETF), the IEEE (Institute of Electrical and Electronics Engineers), the WiMAX Forum and the like are working on standards or specifications for telecommunication network and access environments.

In order to optimize, secure and manage mobile networks, corresponding measures based on machine learning (ML) are used. This approach may however lead to increased collection and processing of data from network functions. While conventional ML approaches rely on the assumption of having the data and processing heads in a central entity, this is not always feasible in wireless communications applications because of the inaccessibility of private data and large communication overhead required to transmit raw data to central ML processors.

Many applications in mobile networks require a large amount of data from multiple distributed sources like UEs or distributed gNBs to be used to train a single common model. To minimize the data exchange between the distributed units from where the data is generated and the centralized unit(s) where the common model is created, the concept of Federated learning (FL) may be applied. FL is a form of machine learning where, instead of model training at a single node, different versions of the model are trained at the different distributed hosts (FL clients). This is different from distributed machine learning, where a single ML model is trained at distributed nodes to use computation power of different nodes. In other words, FL is different from distributed learning in the sense that: 1) each distributed node in a FL scenario has its own local training data which may not come from the same distribution as the local training data at other nodes; 2) each node computes parameters for its local ML model and 3) the central host (FL server) does not compute a version or part of the model but combines parameters of all the distributed models to generate a main model (aggregation of the local models to a global model). An objective of this approach is to keep the training dataset where it is generated and perform the model training locally at each individual learner in the federation.

In the following, a terminology is used which considers several aspects of ML and FL. Specifically, for example, the following terms may be used. Data collection means a process of collecting data by the network nodes, management entity, or UE for the purpose of AI/ML model training, data analytics and inference. Furthermore, AI/ML Model means a data driven algorithm that applies AI/ML techniques to generate a set of outputs based on a set of inputs. In addition, AI/ML model training defines a process to train an AI/ML Model [by learning the input/output relationship] in a data driven manner and obtain the trained AI/ML Model for inference. AI/ML model inference defines a process of using a trained AI/ML model to produce a set of outputs based on a set of inputs. Moreover, AI/ML model validation means a subprocess of training, to evaluate the quality of an AI/ML model using a dataset different from one used for model training, that helps selecting model parameters that generalize beyond the dataset used for model training. Furthermore, AI/ML model testing defines subprocess of training, to evaluate the performance of a final AI/ML model using a dataset different from one used for model training and validation. Differently from AI/ML model validation, testing does not assume subsequent tuning of the model. Model monitoring means a procedure that monitors the inference performance of the AI/ML model. Moreover, functionality identification is a process/method of identifying an AI/ML functionality for the common understanding between the NW and the UE (it is to be noted that information regarding the AI/ML functionality may be shared during functionality identification). Finally, federated learning/federated training defines a machine learning technique that trains an AI/ML model across multiple decentralized edge nodes (e.g., UEs, gNBs, also referred to as FL clients) each performing local model training using local data samples. The technique requires multiple interactions of the model, but no exchange of local data samples.

In the FL procedure, after training a local model, each individual learner transfers its local model parameters, instead of the (raw) training dataset, to an aggregating unit. The aggregating unit utilizes the local model parameters to update a global model which may eventually be fed back to the local learners for further iterations until the global model converges. As a result, each local learner benefits from the datasets of the other local learners only through the global model, shared by the aggregator, without explicitly accessing high volume of (potentially privacy-sensitive) data available at each of the other local learners.

FL training process can be explained by the following main steps:
Initialization: A machine learning model (e.g., linear regression, neural network) is chosen to be trained on local nodes and initialized.
Client selection: a fraction of local nodes may be selected to start training on local data. The selected nodes acquire the current statistical model while the others wait for the next federated round.
Reporting and Aggregation: each selected node sends its local model to the central function (FL server) for aggregation. The central function aggregates the received models and sends back the model updates to the nodes.
Termination: once a pre-defined termination criterion is met (e.g., a maximum number of iterations is reached), the central function aggregates the updates and finalizes the global model.

Some example deployment options for FL server and FL client in 3GPP networks are shown in Table 1.

TABLE 1
Example FL deployment options in 3GPP networks

| | FL Server (or aggregator) | FL Client |
|---|---|---|
| Option 1 | Cross-domain management | Individual management |
| | domain (cross-domain MDAF | domains(s) |
| | or cross-domain MLEntity) | |
| Option 2 | RAN management domain | gNodeB(s) |
| | (RAN MDAF or MLEntity) | |
| Option 3 | Core management domain (Core | NWDAF(s) |
| | MDAF or MLEntity) | |
| Option 4 | Central NWDAF | Distributed NWDAF(s) |
| Option 5 | NWDAF | UE(s) |
| Option 6 | gNodeB | UE(s) |
| Option 7 | Non-real-time RIC (rApp) | Real-time RIC(s) (xApp(s)) |
| Option 8 | Real-time RIC (xApp) | gNodeB(s) |

Federated learning is used, for example, as a model for training a network wide anomaly detector using neural networks, specifically autoencoders. In this setting, each client (network node) sends the data on detected healthy traffic labelled as “normal” (if available also anomaly labelled traffic data could be sent) to the aggregator. The aggregator then trains a universal autoencoder model that can detect anomaly across all the network, as its trained by all the networks data.

However, although FL is theoretically effective in safeguarding clients' privacy, it faces significant challenges in practical implementation.

For example, the nature of FL introduces new threat vectors such as data poisoning and model poisoning. In particular (but not only), if UEs are involved as FL clients in FL training, the threat surface is essentially enlarged.

In federated learning, since the FL clients train the model using their local data and only send a model parameter to the FL server (aggregator), if an FL client is malicious, i.e. shows a harmful behavior or the like, it can train the model using tampered data and can then send the model parameter to the FL server. This can then lead to adversarial attack wherein the global model that will then be generated by the FL server can misclassify the entities during inference in a way the malicious FL client(s) intended to. The problem may occur in different FL deployment options, for example in a telecommunication network. That is, for example, the risk of attacks that can happen on autoencoders has to be considered and techniques for detection thereof are to be required.

As indicated above, the chance of attacks in a distributed system is high. Consequently, according to examples of embodiments, a mechanism is proposed which provides a method and algorithm to detect attacks on an FL system, such as a data and/or model poisoning attack, in particular an FL system based on autoencoders, and identify malicious FL clients. Furthermore, measures for mitigating the attack are proposed.

In the following, different examples of embodiments will be described for illustrating a processing for conducting control processes in a communication network allowing network sharing also in an indirect matter. To this end, as one example of a communication network to which examples of embodiments may be applied, a communication network architecture based on 3GPP standards for a communication network, such as 5G, is used without restricting the disclosure to such an architecture. It would be apparent to a person skilled in the art that examples of embodiments may also be applied to other kinds of communication networks, e.g. Wi-Fi, worldwide interoperability for microwave access (WiMAX), Bluetooth®, personal communications services (PCS), ZigBee®, wideband code division multiple access (WCDMA), systems using ultra-wideband (UWB) technology, mobile ad-hoc networks (MANETs), wired access, etc. Furthermore, without loss of generality, the description of some examples of embodiments is related to a mobile communication network, but the principles of described herein can be extended and applied to any other type of communication network, such as a wired communication network as well.

The following examples and embodiments are to be understood only as illustrative examples. Although the text herein may refer to “an”, “one”, or “some” example(s) or embodiment(s) in several locations, this does not necessarily mean that each such reference is related to the same example(s) or embodiment(s), or that the feature only applies to a single example or embodiment. Single features of different embodiments may also be combined to provide other embodiments. Furthermore, terms like “comprising” and “including” should be understood as not limiting the described embodiments to consist of only those features that have been mentioned; such examples and embodiments may also comprise features, structures, units, modules etc., that have not been specifically mentioned.

A basic system architecture of a (tele) communication network, including a mobile communication system, where some examples of embodiments are applicable, may include an architecture of one or more communication networks, including wireless or wired access network subsystem(s) and core network(s). Such an architecture may include one or more communication network control elements or functions, access network elements, radio access network elements, access service network gateways or base transceiver stations, such as a base station (BS), an access point (AP), a NodeB (NB), an eNB or a gNB, a distributed or a centralized unit, which controls a respective coverage area or cell(s) and with which one or more communication stations (communication elements or communication functions) such as user equipments (UEs), e.g. user devices or terminal devices, or another device having a similar function, such as a modem chipset, a chip, a module etc., which can also be part of a station, an element, a function or an application capable of conducting a communication, such as a UE, an element or function usable in a machine-to-machine communication architecture, or attached as a separate element to such an element, function or application capable of conducting a communication, or the like, are capable to communicate via one or more channels via one or more communication beams for transmitting several types of data in a plurality of access domains. Furthermore, core network elements or network functions, such as gateway network elements/functions, mobility management entities, a mobile switching center, servers, databases, and the like, may be included.

The general functions and interconnections of the described elements and functions, which also depend on the actual network type, are understood by those skilled in the art and described in corresponding specifications so that a detailed description thereof is omitted herein. However, it is to be noted that several additional network elements and signaling links may be employed for communication to or from an element, function or application, like a communication endpoint, a communication network control element, such as a server, a gateway, a radio network controller, and other elements of the same or other communication networks besides those described in detail herein below.

A communication network architecture as being considered in examples of embodiments may also be able to communicate with other networks, such as a public switched telephone network or the Internet, as well as with individual devices or groups of devices being not considered as a part of a network, such as monitoring devices like cameras, sensors, arrays of sensors, and the like. The communication network may also be able to support the usage of cloud services for virtual network elements or functions thereof, wherein it is to be noted that the virtual network part of the telecommunication network can also be provided by non-cloud resources, e.g. an internal network or the like. It should be appreciated that network elements of an access system, of a core network etc., and/or respective functionalities may be implemented by using any node, host, server, access node or entity etc. being suitable for such a usage. Generally, a network function can be implemented either as a network element on a dedicated hardware, as a software instance running on a dedicated hardware, or as a virtualized function instantiated on an appropriate platform, e.g., a cloud infrastructure.

Furthermore, a network element or network functions, such as a gNB, a UE, or other network elements or network functions, such as network elements and network functions acting as a FL server or FL client, as described herein, and any other elements, functions or applications may be implemented by software, e.g. by a computer program product for a computer, and/or by hardware. For executing their respective processing, correspondingly used devices, nodes, functions or network elements may include several means, modules, units, components, etc. (not shown) which are utilized for control, processing and/or communication/signaling functionality. Such means, modules, units and components may include, for example, one or more processors or processor units including one or more processing portions for executing instructions and/or programs and/or for processing data, storage or memory units or means for storing instructions, programs and/or data, for serving as a work area of the processor or processing portion and the like (e.g. ROM, RAM, EEPROM, and the like), input or interface means for inputting data and instructions by software (e.g. floppy disc, CD-ROM, EEPROM, and the like), a user interface for providing monitor and manipulation possibilities to a user (e.g. a screen, a keyboard and the like), other interface or means for establishing links and/or connections under the control of the processor unit or portion (e.g. wired and wireless interface means, radio interface means including e.g. an antenna unit or the like, means for forming a radio communication part etc.) and the like, wherein respective means forming an interface, such as a radio communication part, can be also located on a remote site (e.g. a radio head or a radio station etc.). It is to be noted herein that processing portions should not be only considered to represent physical portions of one or more processors, but may also be considered as a logical division of the referred processing tasks performed by one or more processors.

It should be appreciated that according to some examples, a so-called “liquid” or flexible network concept may be employed where the operations and functionalities of a network element, a network function, or of another entity of the network, may be performed in different entities or functions, such as in a node, host or server, in a flexible manner. For instance, a “division of labor” between involved network elements, functions or entities may vary case by case.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims. As a further example, as used herein, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Furthermore, as used herein, “at least one of the following:” and “at least one of” and similar wording, where the list of two or more elements are joined by “and” or “or”, mean at least any one of the elements, or at least any two or more of the elements, or at least all the elements.

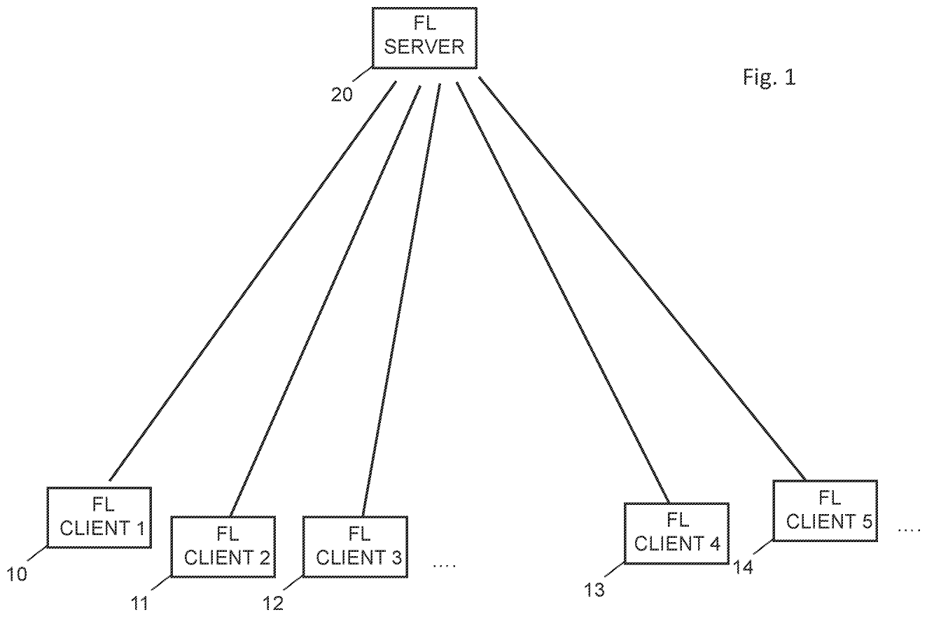

FIG. 1 shows a diagram illustrating an example for a setup of an FL procedure. Specifically, FIG. 1 shows a simplified FL environment and use case in which an anomaly detection according to example of embodiments is explained.

Specifically, in FIG. 1, reference signs 10, 11, 12, 13 and 14 represent a respective FL client 1 to 5. Reference sign 20 denotes an FL server. It is to be noted that the number of FL clients is not limited to that shown in FIG. 1, wherein more or less FL clients can be included in the FL system.

Each FL client 10 to 14 is provided with a global model from the FL server 20, starting with an initial global model which is then followed, in each iteration of the FL procedure, by an aggregated model. On the other hand, each FL client 10 to 14 locally trains, on the basis of a corresponding local dataset, the model and sends to the FL server 20 a local model update based on the local training. The local model updates received by the FL server are then used for preparing the global model used in the next iteration.

In the example shown in FIG. 1, it is now assumed that two (wherein the actual number is not limited to this) of the clients 10 to 14 are malicious clients which train the local model using poisoned local data and share a poisoned model update with the FL server 20. For example, it is assumed that client 4 13 and client 5 14 are such malicious clients.

Since the FL server 20 treats the poisoned model updates as also regular update and merges them with the global model, the complete aggregated global model is poisoned. As described later, this may result in an accuracy decrease and changes in false positive and negative ratio.

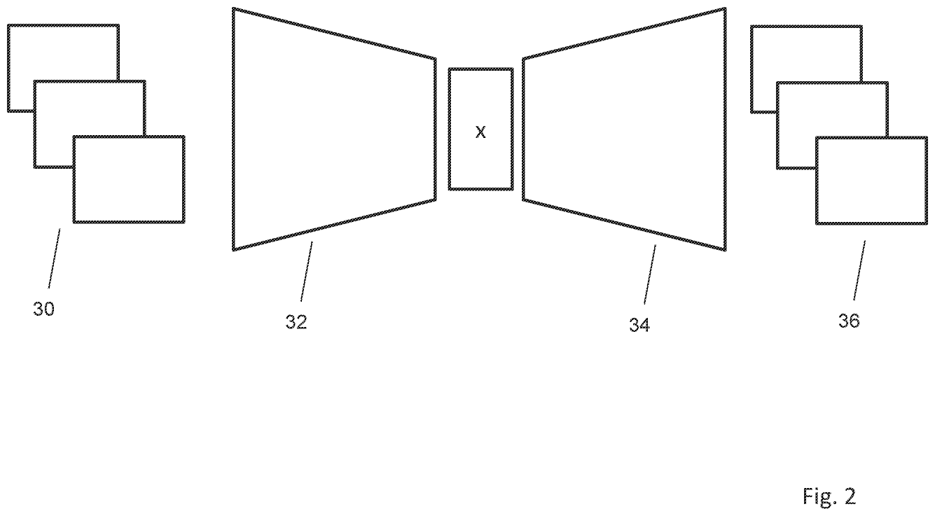

FIG. 2 shows a diagram illustrating an example of an autoencoder structure. As indicated above, autoencoders are used according to examples of embodiments as a type of artificial neural network. The autoencoder has two functions: an encoding function 32 that transforms input data 30 by mapping the data to a code, and a decoding function 34 that recreates the input data as reconstruction data 36 from the encoded representation. A reconstruction quality of the autoencoder describes how close a reconstruction to the original is.

According to examples of embodiments, it is assumed as an example that a baseline ML model being used is a fully connected autoencoder with 4 encoder layers and 4 decoder layers. Since the autoencoder is trained to reconstruct the data it is trained upon, it is suitable in the anomaly detection applications. The model is trained on normal data (for example normal traffic data), and any significant deviation from the normal behavior can be termed as anomaly (that is an attack). The deviation is usually calculated using a reconstruction error for each test sample.

Thus, in the case of FL based anomaly detection, each FL client trains the autoencoder using the corresponding local dataset (e.g. local traffic data) and sends the model updates to the FL server 20. In the example of FIG. 1, as indicated above, since two clients are assumed to be malicious clients (e.g. FL client 4 and FL client 5), these FL clients send engineered model parameters to fool the anomaly detector at the aggregator. For example, the malicious clients provide engineered model weight updates such that the global model mis-detects anomaly traffic to normal traffic, or increases the false alarm probability, where the normal traffic too often is flagged as anomaly. Both of these two attacks can render the anomaly detection useless over time.

Therefore, according to examples of embodiments, a mechanism is proposed which allows to detect if there is any attack using poisoned local training data by a malicious FL client and thereby corrupting the complete global model sent to all the FL clients.

Specifically, according to examples of embodiments, a multistep approach is proposed. According to one example of embodiments, the FL server first clusters the model updates being sent by all the FL clients. Then in the case there is a deviation in model related parameters, such as cluster centroids, and a deviation in the pattern of model updates received is determined, the FL server constantly monitors quality metrics, such as accuracy, precision, recall for every FL round for each FL client update. Accuracy, precision, and recall are metrics (quality metrics) to determine how good the FL global model (or any other machine learning model) reflects the reality. They are defined as follows:

$$Accuracy = Correct predictions / total prediction number$$

$$Precision = \frac{True Positive}{True Positive + False Positive}$$

$$Recall = \frac{True Positive}{True Positive + False Negative}$$

Then, in case of any abnormal deviation in the metrics in subsequent FL rounds, the FL server initiates a further check, such as a deep inspection wherein it analyses the model parameters for every neural network layer and FL client. The results of the FL client under suspicion are compared with corresponding values obtained for non-suspicious clients (i.e. clients verified to be normal clients, i.e. not malicious clients).

In the case that there is clear deviation between the suspicious client and the normal client, there is a high probability that the suspicious client is indeed a malicious client so that further measures can be taken, such as removing the FL client in question from the FL process, and/or to inform the client in question (i.e. the user of the malicious client) about the result. By means of this it is possible to target a data poisoning attack on an autoencoder based anomaly detection in an FL wherein an algorithm which is easy to implement can be used which allows an efficient operation at the aggregator side.

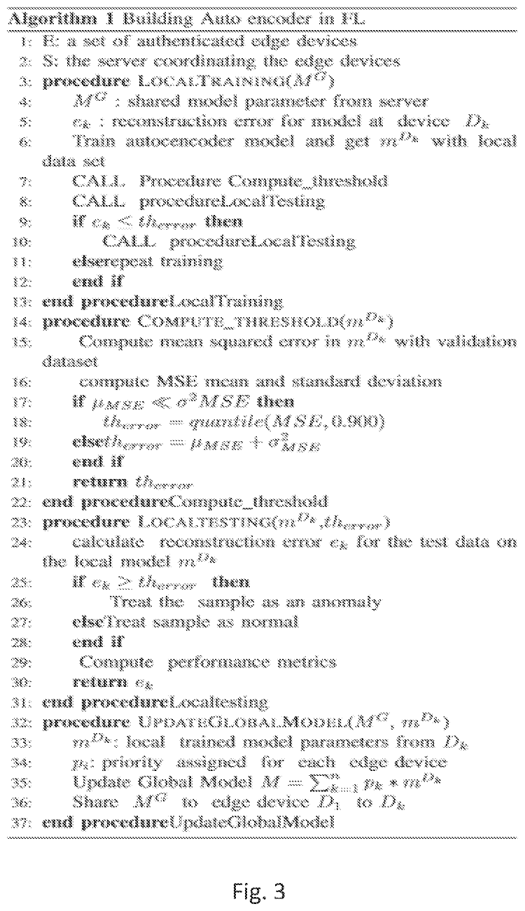

FIG. 3 shows an example of an algorithm to build an autoencoder model using FL according to examples of embodiments. The algorithm concerns a set of edge devices being FL clients for the FL procedure, and a server coordinating the edge devices.

The algorithm comprises different procedures, i.e. a LocalTraining procedure for conducting a training of a model (which is received from the server) with a local dataset, a ComputeThreshold procedure for computing a threshold to be used in a test process of the (trained) model, a LocalTesting procedure in which the trained model is tested with regard to normal or anormal, and an UpdateGlobalModel procedure for updating the global model.

In the LocalTraining procedure, which includes steps 3 to 13, the FL client receives the global model from server. In a first iteration, the received global model is an initial global model. Then, the FL client trains the model by using the local dataset. After a required number of iterations, the FL client calls the ComputeThreshold procedure to get a threshold value to be used in the local testing (this threshold is referred to also as a fourth threshold). The ComputeThreshold procedure is described below in connection with steps 14 to 22.

In the ComputeThreshold procedure, first, in the model locally trained, a predetermined validation dataset is used for computing the mean squared error (MSE). Then, a mean and a standard deviation of the MSE are computed and compared. If the mean of the MSE is much smaller than the standard deviation of the MSE (i.e. smaller by a fifth threshold), this shows a high deviation in the data distribution. In this case, as a procedure for obtaining the fourth threshold, a quantile thresholding mechanism is used. A quantile is the value below which a fraction of observations in a group falls. Otherwise, in case the mean of the MSE is not smaller than the standard deviation of the MSE by the fifth threshold, as a thresholding mechanism, the mean of the MSE is added to the standard deviation of the MSE for calculating the fourth threshold. Finally, the fourth threshold being calculated as indicated above is returned to the LocalTraining procedure.

Returning to the in the LocalTraining procedure, after getting the threshold (i.e. the fourth threshold), the FL client calls the LocalTesting procedure in order to obtain the reconstruction error on the test data. The LocalTesting procedure is described below in connection with steps 23 to 31.

In the LocalTesting procedure, the reconstruction error is computed for the test data on the local model. Then, the reconstruction error is compared with the fourth threshold being computed in the ComputeThreshold procedure described above. In case the reconstruction error is equal to or greater than the fourth threshold, this is considered as an anomaly. Otherwise, in case the reconstruction error is smaller than the fourth threshold, the test sample is considered as normal. Then, performance matrices for a quality metric such as accuracy, precision, recall, F1 score are computed. Thereafter, the reconstruction error is returned to the LocalTraining procedure.

Back to the LocalTraining procedure, if it is determined that the performance matrix is in satisfactory range, the trained model is shared with the FL server for global aggregation. Otherwise, in case the performance matrix is not in satisfactory range, the local training process is repeated.

In the UpdateGlobalModel procedure, which corresponds to steps 32 to 37, the global model to be provided to the respective edge devices is updated according to the trained local model parameters shared by the respective FL clients, wherein a priority factor assigned to each client can be considered as a weighting factor, for example. The updated global model is then again shared with the respective local clients. The priority factor can be set, for example, to 1 as default for all the clients. However, also other values can be set, e.g. by a user, for example for providing more weightage to some clients if required. For example, clients may have higher weightage when an amount of training data it holds is higher, or higher weightage may be based upon the past history of its performance.

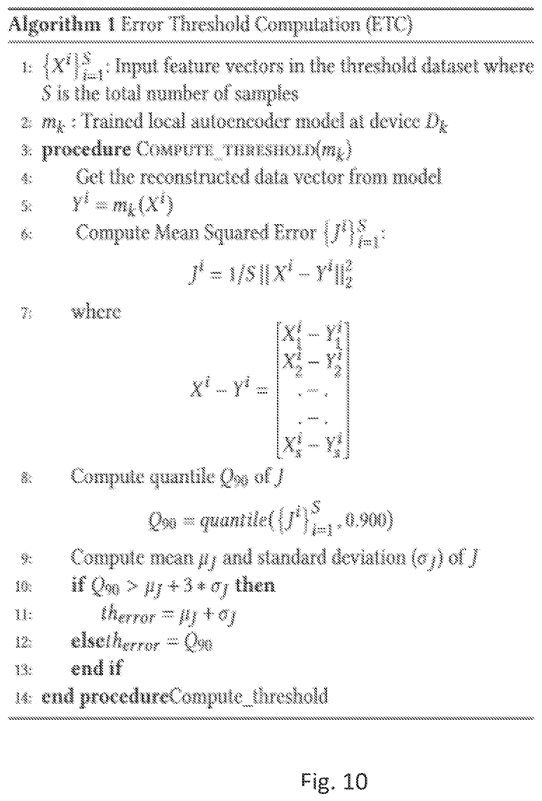

With regard to FIG. 10, an alternative procedure is described for obtaining the fourth threshold, i.e. an error threshold. The algorithm shown in FIG. 10 can be used, for example, instead of the ComputeThreshold procedure described above, or is generally called after a local training of the model is completed.

According to the present example of embodiments, the algorithm according to FIG. 10 is used to define a procedure of a reconstruction error threshold computation at each client device which is used while testing the model.

Specifically, the algorithm in FIG. 10 uses {X}^{N}ᵢ₌₁ as input feature vectors in a threshold data set. The threshold data set is similar to a training data set of the local device which has only benign samples.

Next, reconstructed data vector Yⁱ is obtained from the local trained model mₖ wherein the input feature dataset Xⁱ is used.

Then, a mean squared error Jⁱ is computed for all the samples in the dataset, e.g. by using the formulas in steps 6 and 7 of FIG. 10. Next, the 90% quantile Q₉₀ on the J values is determined. As indicated above, the quantile is the value below which a fraction of observations in a group falls.

The quantile Q₉₀ is compared with mean of the mean squared error and k times (e.g. 3 times or more) the standard deviation of the mean squared error. By means of this, it is possible to recognize if the variance of the data samples in the threshold set is high. For example, in the case of non-IID dataset, the distributions of the data samples are different.

Then, the fourth threshold is determined in a similar manner as described above for the ComputeThreshold procedure, i.e. either the quantile Q₉₀ is used as the fourth threshold value thₑᵣᵣₒᵣ or the sum of the mean of the mean squared error and the standard deviation of the mean squared error is used as the fourth threshold value thₑᵣᵣₒᵣ, depending on which of quantile Q₉₀ and the mean of the mean squared error and 3 times the standard deviation of the mean squared error is smaller.

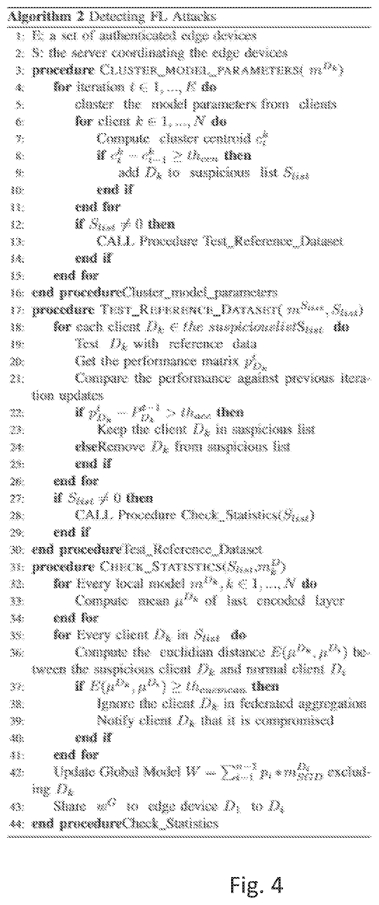

Next, with reference to FIG. 4, an example of an algorithm to detect FL attacks according to examples of embodiments is shown. Also this algorithm concerns a set of edge devices being FL clients for the FL procedure, and a server coordinating the edge devices.

According to examples of embodiments, for detecting FL attacks, a 3-step procedure is implemented. By means of these steps, a list of suspicious clients is optimized in order to identify a malicious client with high probability.

The algorithm comprises different procedures, i.e. a ClusterModelParameter procedure, a TestReferenceDataset procedure and a CheckStatistic procedure.

In the ClusterModelParameter procedure, which is illustrated in FIG. 4 in steps 3 to 16, for each FL client providing local model data to the FL server, the local model parameters from the respective FL clients are clustered. Clustering is done, for example, according to k-means, or another suitable method. By means of the clustering, it is possible to recognize if a model related parameter, such as cluster centroids, have changed beyond a first threshold from the previous iteration. This is done in every iteration. In case it is detected that one or more of the FL clients sharing their local model data show such a change beyond the first threshold, the respective FL client is added to a list of suspicious clients. When the list of suspicious clients is not empty, a further step of the 3-step procedure is conducted.

That is, in the TestReferenceDataset procedure, which is illustrated in FIG. 4 in steps 17 to 30, for each FL client comprised in the list of suspicious clients, a test runs with the respective models on a reference dataset which is available at the FL server. On the basis of the test, a performance matrix is obtained, and the obtained performance matrix is checked against a previous interation. In case it is determined that there is deviation from the previous iteration which is beyond a second threshold, the FL client being tested is kept in the list of suspicious clients, or it is added to a confirmed suspicious client list list. Otherwise, in case there is no significant performance change compared to the previous iteration, the FL client in question can be removed from the list of suspicious clients. When the list of confirmed suspicious clients is not empty, a next step of the 3-step procedure is conducted.

In the CheckStatistic procedure, which is illustrated in FIG. 4 in steps 31 to 44, for the clients contained in the confirmed suspicious list, a mean of the last encoded layer in the autoencoder is computed. This mean is then compared with the mean of a normal client's autoencoder model encoded layer (i.e. of a normal FL client which is verified as being not malicious, for example). If the deviation (e.g. an Euclidian distance) is beyond a third threshold, this confirms that this client is a malicious FL client.

Based on this identification of one or more malicious FL clients, a further process may be started in order to consider this result in the global model update procedure conducted on the FL servier side. For example, for the aggregated model, all results or data derived from the malicious client(s) are ignored. Furthermore, a notification process can be executed in order to notify the client about the result that an attack happened. Moreover, as a mitigation measure, the client identified as being malicious is removed from the FL process.

In the following, results of the above described processing regarding building of an autoencoder and detecting FL attacks are explained in connection with results of a simulation process of the FL environment. As a dataset used for the simulation, for r example, a dataset according to CICIDS 2018 is used. This dataset contains network traffic intrusion detection patterns, wherein both normal traffic data as well as attack signature data are provided. The dataset contains seven different attack scenarios, i.e. Brute-force, Heartbleed, Botnet, DoS, DDoS, Web attacks, and infiltration of the network from inside.

In the simulation, it is assument that an FL system is provided which contains four FL Clients, from which two are genuine and two are malicious. The malicious FL clients will be referred to as D1 and D2, while the normal clients are denoted as D3 and D4. The baseline ML model is assumed as a fully connected autoencoder with four encoder layers and four decoder layers

With regard to results of the quality metrics such as FL Accuracy etc, and dynamic threshold for anomaly detection, Table 2 shows corresponding results for the four clients being considered in the simulation. Specifically, Table 2 is related to the case where the threshold (i.e. the fourth threshold as described above) is calculated by adding the mean of the MSE and the standard deviation of the MSE (see also FIG. 3).

TABLE 2

| | Client1 | Client2 | Client3 | Client4 |
|---|---|---|---|---|
| Accuracy | 99.996 | 81.615 | 99.670 | 55.719 |
| Precision | 1 | 0.99 | 0.993 | 0.978 |
| Recall | 1 | 0.587 | 1 | 0.004 |
| F1 score | 99.9 | 73.937 | 99.631 | 0.747 |

As can be seen in Table 2, for one client, i.e. client 4, the accuracy value thereof is low. Therefore, for client 4, a different thresholding scheme is used, as discussed in connection with FIG. 3, i.e. a quantile on the MSE values (0.900) is used). Thus, the performance of Client 4 is improved as indicated in Table 3.

TABLE 3

| | Client4 |
|---|---|
| Accuracy | 92.570 |
| Precision | 0.885 |
| Recall | 0.957 |
| F1 score | 91.966 |

As can be seen from Table 2, the accuracy value can be imprived by changing the thresholding scheme.

It is to be noted that in order to visualize a data distribution plot from which the correctness of using different thresholding schemes for Client 4 can be deduced, a so-called t-distributed stochastic neighbor embedding (t-SNE) can be employed which is a statistical method for visualizing high-dimensional data by giving each datapoint a location in a two or three-dimensional map.

Next, accuracy results are depicted in Table 4, wherein a comparison between a case where no malicious client is present and a case where two of the four clients are malicious clients are shown.

TABLE 4

| | Accuracy without | Accuracy with malicious clients |
|---|---|---|
| Clients | attack | (D1 and D2) |
| Client1 | 99.996 | 66.2 |
| Client2 | 81.615 | 63.96 |
| Client3 | 99.67 | 70.13 |
| Client4 | 92.57 | 70.36 |

As can be seen from Table 4, in case of malicious clients, the accuracy drops significantly for all clients due to the impact on the global model.

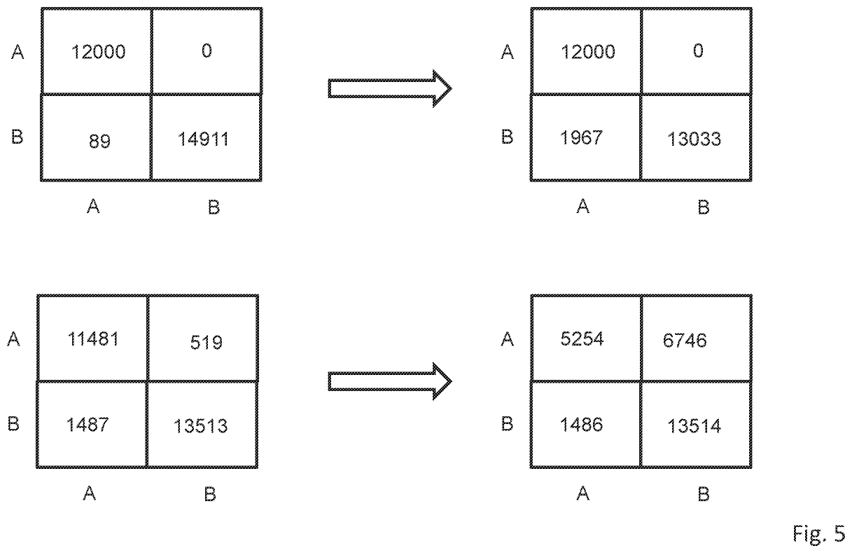

FIG. 5 shows a a diagram indicating performance matrices as a result of the attacks. The left parts in FIG. 5 represent the case when no malicious client is present while the right parts show a case with malicious clients. “A” denotes an anormal while “B” denotes a benign result. Thus, in each diagram, the upper left section represents false-false, the upper right section represents false-true, the lower left section represents true-false, and the lower right portion represents true-true.

As can be seen in FIG. 5, the attack by malicious clients has an impact on the correctness of the determination by the model. That is, false positives and false negatives increase in case of an attack. Specifically, in the upper case, more benign is treated as anormal, while in the lower case, more anormal traffic is classified as normal data.

That is, according to examples of embodiments, results of the detection algorithm can be summarized as follows.

Before doing a federated aggregation, the last encoded layer weight is extracted for each client model. Then, the Euclidian distance between the layer weight tensors of different clients is determined. Mean and variance values of these Euclidian distance tensors are computed. When an attack occurs, an attacked model would shows a significant deviation on these values.

In the following Table 5, mean values on the Euclidian are shown. As indicated above, the devices 1 and 2 are malicious clients, i.e. attacker.

TABLE 5

| Mean | Device 1 | Device 2 | Device 3 | Device 4 |
|---|---|---|---|---|
| Device 1 | 0 | 0.07 | 0.4591 | 0.5586 |
| Device 2 | 0.07 | 0 | 0.7756 | 0.6757 |
| Device 3 | 0.4591 | 0.7756 | 0 | 0.0068 |
| Device 4 | 0.5586 | 0.6757 | 0.0068 | 0 |

As described above, devices 1 and 2 are the attackers in the simulation. When now comparing the encoded layer model parameters between device 1 and device 3 (or device 2 and device 4), the difference is can be seen so that devices 1 and 2 are identifiable as the attacker.

While the above described examples of embodiments uses a multistep approach where first all potential suspicious clients are determined and then, by using additional tests, this suspicion is either confirmed or discarded to get the malicious clients, in the following, another example of embodiments is described which uses another approach. Specifically, in this example of embodiments, it is first determined, by using an aggregated model based on the currently obtained local models, and a former global model whether there is any malicious client present in the FL procedure. If this is confirmed, then every local model is checked in order to identify which client is a malicious client. Further measures to be taken, such as removing the FL client in question from the FL process, and/or to inform the client in question (i.e. the user of the malicious client) about the result, are similar to the above described example of embodiments. Also by using this type of algorithm it is possible to target a data poisoning attack on an autoencoder based anomaly detection in an FL wherein an algorithm which is easy to implement can be used which allows an efficient operation at the aggregator side.

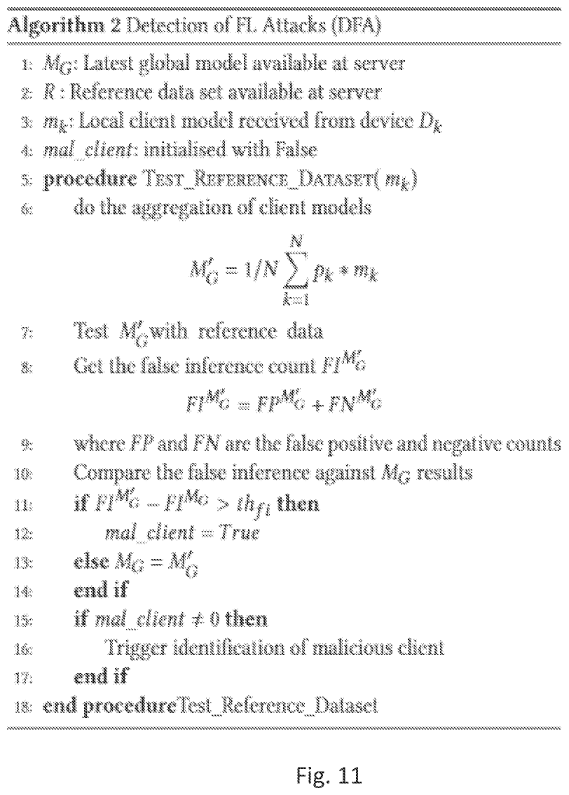

FIG. 11 shows an example of a corresponding algorithm for detecting FL attacks according to further examples of embodiments. Also this algorithm concerns a set of edge devices being FL clients for the FL procedure, and a server coordinating the edge devices.

In the algorithm shown in FIG. 11, the latest global model (i.e. iteration n−1) is available at the server, as well as a reference data set R. Local client models mk are received from each edge device Dk involved in the FL procedure. One the server receives all the local models from the FL clients, the server coducts an aggregation procedure for determining a global model of the current iteration n of the FL procedure. In the aggregation procedure, a factor pₖ can be used which indicates a priority that is given to each edge device. The factor pₖ can be configured by an operator, for example. The priority factor pₖ can be set, for example, to 1 as default for all the clients. However, also other values can be set, e.g. by a user, for example for providing more weightage to some clients if required. For example, clients may have higher weightage when an amount of training data it holds is higher, or higher weightage may be based upon the past history of its performance.

Then, the aggregated model (if iteration n) is subjected to a test with the reference dataset. This dataset, which is available only at server, is assumed to be not corrupted.

As a result of the test, a false inference count is obtained. The false inference count is the sum of false positives and false negatives. False positives are the number of instances where the model predicted the samples as abnormal though the are actually benign. False negatives are the number of instances where the model predicts the samples as benign though they actually belong to abnormal class.

The false inference count obtained by the test with the aggregated model (iteration n) is then compared with a false inference count which is obtained by a test with the lates global model shared in the FL procedure with the clients, i.e. the global model of iteration n−1 of the FL procedure. In other words, the global reference model against which the client updates are compared can be obtained from the n−1 iteration of the FL procedure wherein accuracy degradation/impact on the aggregated model performance is observed from present iteration n of the FL procedure.

If the difference between the respective results is greater than a sixth threshold th_{fi}, presence of malicious client is suspected. In this case, a procedure to identify malicious clients is initiated.

The sixth threshold is configurable based on user configuration. For example, the sixth threshold reflects the criticality of the application for which the model is to be generated. For example for critical applications, the threshold can have a comparable small value.

Otherwise, if the difference between the respective results is not greater than the sixth threshold th_{fi}, presence of malicious client is not suspected. In this case, the aggregated model can be used as the new global model and updated in the server, wherein the new global model can be shared to all clients.

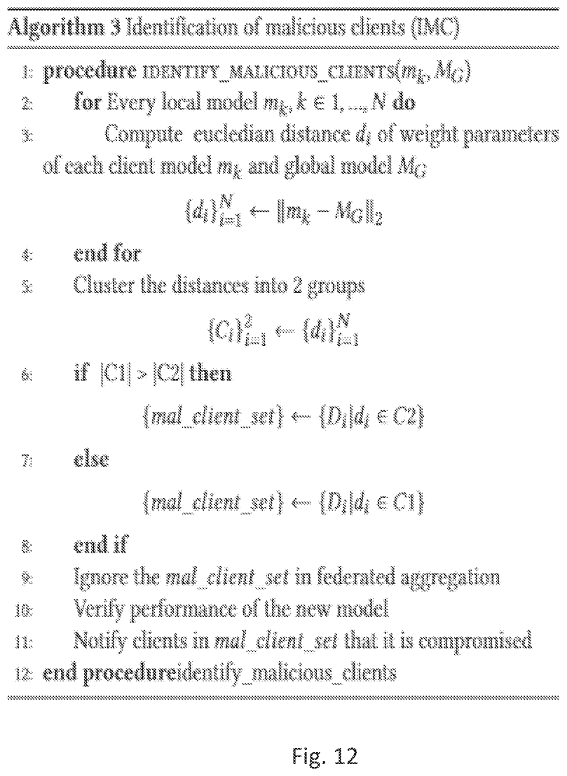

With regard to FIG. 12, an algorithm is described which is used to identify malicious clients. The algorithm in FIG. 12 is executed, for example, when the result of the algorithm described in connection with FIG. 11 results in a determination of the presence of a malicious client due to the reference data testing at the server.

In a first step, the Euclidian distance between each client model parameters weight and global model parameter weight is taken.

It is to be noted that, according to some examples of embodiments, for identifying at least one malicious client, Euclidian distances of weight parameters of each layer of the local model and each layer of the global model can be taken. That is, the client model updates are compared layer wise against the global model parameters. The deviation can be seen either in all the layers or in one of the layers. This depends, for example, on the neural network architecture which is used.

Next, the computed Euclidian distances are grouped into two clusters C1 and C2. The grouping of the respective Euclidian distances is based on the value of the respective Euclidian distance, for example.

The clients belonging to group or cluster haven the smaller cardinality are identified as malicious clients. This will be illustrated in FIG. 13.

The concept used in the present example of embodiments based on the algorithms in FIGS. 11 and 12 is that a model being trained with similar kind of data have similar model parameters. Aggregation is performed again by eliminating the malicious clients and verify the performance is not impacted. Malicious clients can be notified about the attack.

FIG. 13 shows an example of a process based on the above described algorithms in FIGS. 11 and 12. Specifically, FIG. 13 refers to a tensor of the global model as a reference model against which all the client parameters will be measured

Results of a simulation with 10 clients, of which two are assumed to be malicious clients, are as follows.
Client 1 and GlobalModel tensor (1.0141)
Client 2 and GlobalModel tensor (1.0063)
Client 3 and GlobalModel tensor (1.0064)
Client 4 and GlobalModel tensor (1.0066)
Client 5 and GlobalModel tensor (1.0142)
Client 6 and GlobalModel tensor (1.0063)
Client 7 and GlobalModel tensor (1.0063)
Client 8 and GlobalModel tensor (1.0062)
Client 9 and GlobalModel tensor (1.0064)
Client 10 and GlobalModel tensor (1.0066)

In view of this result, clusters can then be formed as shown below:
Client 1 in cluster 1
Client 2 in cluster 0
Client 3 in cluster 0
Client 4 in cluster 0
Client 5 in cluster 1
Client 6 in cluster 0
Client 7 in cluster 0
Client 8 in cluster 0
Client 9 in cluster 0
Client 10 in cluster 0

The corresponding cluster distribution is depicted in FIG. 13.

Due to the lower cardinality of the cluster 1, clients 1 and 5 are identified as malicious clients.

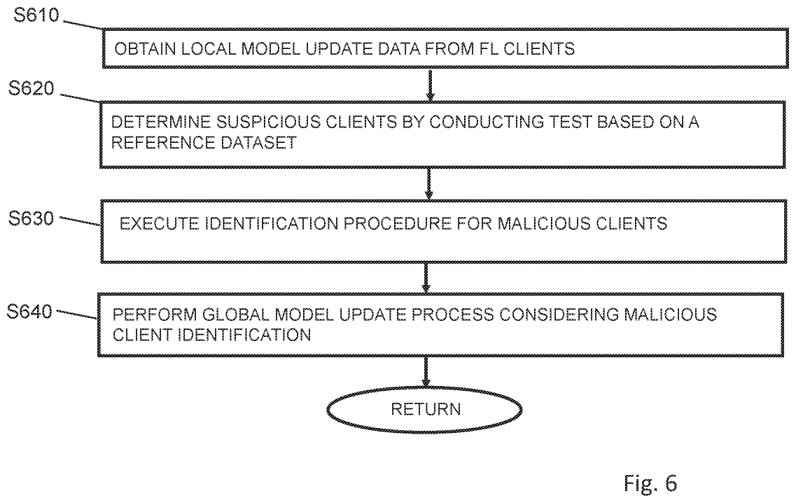

FIG. 6 shows a flow chart of a processing conducted in an FL server according to some examples of the disclosure.

In S610, the FL server obtains local model update data from each of a plurality of FL clients of a FL procedure.

In S620, the FL server determines whether at least one of the plurality of FL clients is a suspicious client showing a harmful behavior in the FL procedure by conducting a test with a reference dataset. That is, in S620, the FL server conducts a first check as to whether the FL procedure may be compromised by at least malicious client. According to examples of embodiments, the determination of suspicious clients is conducted in each iteration of the FL procedure.

In S630, if it is determined that there is at least one suspicious client, an identification procedure is executed for identifying the at least one malicious client.

In S640, when the identification procedure is completed, a global model update process is preformed (i.e. a next iteration of the FL procedure, for example) wherein a result of a malicious client identification is considered.

It is to be noted that according to some examples of embodiment, model data (i.e. in the clients and the server) are based on using an autoencoder comprising a predetermined number of encoders and a predetermined number of decoders. However, it is to be noted that according to some examples of embodiments, other types of neuronal networks having a plurality of processing layers can be employed.

According to some examples of embodiments, a procedure is implemented where, for identifying malicious clients, a first result for suspicious clients is refined by excluding those clients from a suspicious list which are assumed to be not malicious. A corresponding algorithm is explained, for example, in connection with FIG. 4.

For this, according to examples of embodiments, it is determined whether at least one of the plurality of clients is a suspicious client showing a harmful behavior in the FL procedure by tracking changes in model related parameters of each of the plurality of clients. If at least one suspicious client is determined, a test for each suspicious client with the reference dataset is conducted and it is determined on the basis of the test whether at least one of the suspicious clients is a confirmed suspicious client (other clients are excluded from the further check). Then, if at least one confirmed suspicious client is determined, for identifying the at least one malicious client, a statistic check procedure is conducted for each confirmed suspicious client. On the basis of the statistic check, it is determined whether at least one of the confirmed suspicious clients is a malicious client.

Specifically, according to examples of embodiments, for determining whether at least one of the plurality of clients is a suspicious client, the following processing can be executed. First, local model parameters of each of the plurality of clients are clustered. Then, a cluster centroid for each of the plurality of clients is computed. Next, it is detected for each of the plurality of clients whether a change of the cluster centroid is greater than a first threshold (in FIG. 4, th_{cen}). In case the change of the cluster centroid is greater than the first threshold, the corresponding client is added to a candidate list of suspicious clients (other clients are excluded from the further check).

For determining whether a suspicious client is a confirmed suspicious client, the model obtained from the suspicious client on the reference dataset. A performance matrix is obtained on the basis of a result of running the obtained model. Next, the obtained performance matrix is compared with a previously obtained performance matrix of a previous iteration update (for example the directly preceding iteration n−1, in case the current iteration of the FL procedure is n). In the comparison, it is determined whether a change in the performance matrix is greater than a second threshold (in FIG. 4, th_{acc}).

In case the change in the performance matrix is greater than the second threshold, the corresponding suspicious client is added to a candidate list of confirmed suspicious clients. Otherwise, in case the change in the performance matrix is not greater than the second threshold, the corresponding suspicious client is removed from the candidate list of suspicious clients.

In the next phase, it is determined whether a confirmed suspicious client is a malicious client. For this, according to the present examples of embodiments, a mean of a processing layer of the model obtained from the confirmed suspicious client is computed. According to examples of embodiments, the processing layer is the last encoded layer of an autoencoder used in the client to be considered.

Then, the computed mean is compared with a mean of a corresponding processing layer of another client for determining whether a deviation between the means is greater than a third threshold (in FIG. 4, th_{eucmean}). In case the deviation is greater than the third threshold, the corresponding client is identified as a malicious client.

According to examples of embodiment, an Euclidian distance between the computed mean of the confirmed suspicious client and the mean of the corresponding processing layer of the other client is computed. Then, it is determined whether the computed Euclidian distance is greater than the third threshold for identifying whether the confirmed suspicious client is a malicious client.

When the malicious client is identified, each malicious client is excluded by the server from the FL procedure. Alternatively or additionally, each client being identified as being malicious is informed about the result of the identification.

According to some further examples of embodiments, a procedure is implemented where, for identifying malicious clients, an aggregated (global) model of the current iteration of the FL procedure is checked for abnormality. If such an abnormality in the aggregated model is determined, an identification procedure is executed for identifying the respective malicious clients. Corresponding algorithms are explained, for example, in connection with FIGS. 11 and 12.

According to these examples of embodiments, first, it is determined whether at least one of the plurality of clients is a suspicious client showing a harmful behavior in the FL procedure by conducting the test with the reference dataset on the aggregated model which based on the obtained local model update data from each of a plurality of clients. That is, an aggregated model for the current iteration step n of the FL procedure is generated.

According to examples of embodiments, for obtaining the aggregated model based on the obtained local model update data from each of a plurality of clients, a priority factor assigned to each of the plurality of clients can be considered. For example, the priority factor can be set to different values for each client. As an example, a value of 1 can be set as default for all clients. However, it is possible that this value can be individually changed in order to provide more weightage to some clients if needed or desired. For example, a client may have a higher weightage when an amount of training data it holds is higher, or a higher weightage may be based upon past history of the client's performance.

When the test using the reference dataset is conducted on the aggregated model, the corresponding result of the test is compared with a result of a previously conducted test of a previous global model using the reference dataset. For example, when an iteration of the FL procedure for the aggregated model to be tested is n, a global model for the test using the reference dataset of an (n−1)th iteration of the FL procedure.

For example, according to examples of embodiments, as the a result of the test, a number of false inferences of the test of the aggregated model and a number of false inferences of the previously conducted test of the previous global model using the reference dataset is determined. Then, a difference of the determined numbers of false inferences is compared with a sixth threshold (in FIG. 11, th_{fi}). For example, the sixth threshold is configurable by a user, e.g. in accordance with a criticality of the application, or the like.

If the comparison shows that the difference of the determined numbers of false inferences is greater than the sixth threshold, is to decided that at least one malicious client is present in the aggregated model.

On the other hand, in case the comparison shows that the difference of the determined numbers of false inferences is smaller than or equal to the sixth threshold, the (current) aggregated model is used as a new updated global model for the further FL procedure.

Next, in case the comparison shows that at least one malicious client is present, a procedure for identifying the at least one malicious client is conducted. In this context, an Euclidian distances of weight parameters of each local model and the global model (on which the local models are based, for example) is computed. The determined Euclidian distances are then grouped in two groups (or clusters). The classification is based e.g. on the value of the respective Euclidian distance. On the basis of the grouping, clients can be identified as being malicious clients. According to some examples of embodiment, the clients belonging to the group having the lower cardinality are identified as being malicious clients.

For example, according to examples of embodiments, for identifying the at least one malicious client, Euclidian distances of weight parameters of each layer of the local model and each layer of the global model are determined. When the determined Euclidian distances are then grouped in the two groups, values of the respective Euclidian distance related to one of the layers of the local model and the global model are considered. Alternatively, values of the respective Euclidian distance related to all layers of the local model and the global model are considered.

According to the present examples of embodiments, when a malicious client is identified, as described above, a new aggregated model is obtained on the basis of the (already) obtained local model update data from each of a plurality of clients, wherein the model data of the malicious clients are excluded. Then, the test with the reference dataset is again conducted, this time on the new aggregated model. Furthermore, a result of the (new) test on the new aggregated model is compared with the result of the previously conducted test of the previous global model using the reference dataset (e.g. the same result used beforehand). By means of this, it is possible to verify that no malicious client is present in the (new) aggregated model, on the basis of the comparison.

Furthermore, according to examples of embodiments, when a malicious client is identified, each client being identified as being malicious is informed about the result of the identification.

In addition, when performing the global model update process considering the result of a malicious client identification, model parameter input from the malicious client are discarded. In addition, an updated model in the next iteration is shared with the plurality of clients involved in the FL procedure excluding the malicious clients.

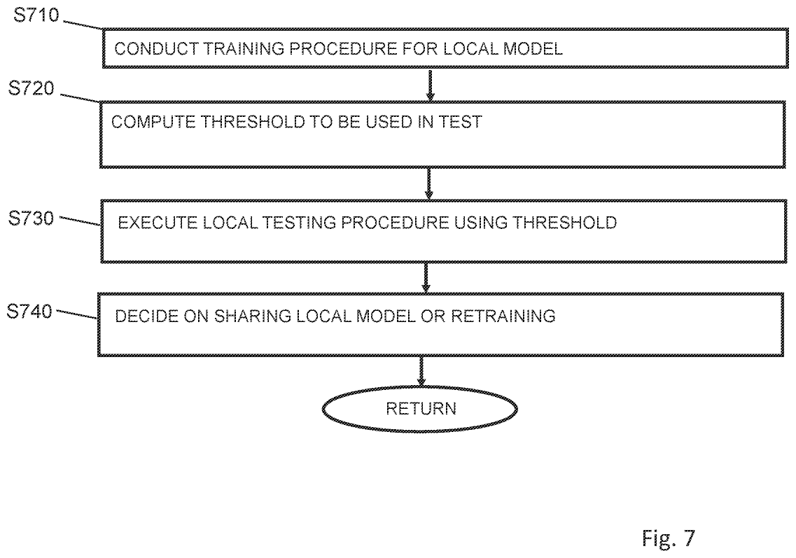

FIG. 7 shows a flow chart of a processing conducted in an FL client according to some examples of the disclosure.

According to some examples of embodiments, as shown in connection with FIGS. 3 and 10, the FL clients is configured to train a local model and to decide as to whether the trained model is to be sent to the FL server for the next FL procedure iteration. According to some examples of embodiments, the local model uses an autoencoder comprising a predetermined number of encoders and a predetermined number of decoders. However, it is to be noted that according to some examples of embodiments, other types of neuronal networks having a plurality of processing layers can be employed.

In S710, a training procedure for a local model which is based on a global model received in a FL procedure is conducted.

In S720, a fourth threshold to be used in a test of the local model is computed (in FIGS. 3 and 10, th₀₀).

According to some examples of embodiments (see e.g. algorithm in FIG. 3, ComputeThreshold procedure), for computing the fourth threshold, a mean squared error in the local model is computed by using a preset validation dataset. Then, a mean and a standard deviation of the computed mean squared error are calculated. Next, it is determined whether the calculated mean of the mean squared error is (significantly) smaller than the standard deviation of the mean squared error, i.e. smaller by a fifth threshold or more.

In case the determination is affirmative, a first procedure for obtaining the fourth threshold is used. Otherwise, a second procedure for obtaining the fourth threshold is used. For example, the first procedure for obtaining the fourth threshold comprises a quantile thresholding mechanism. The second procedure for obtaining the fourth threshold comprises a calculation of the fourth threshold by adding the calculated mean of the mean squared error and the standard deviation of the mean squared error.

Alternatively, as another way for computing the fourth threshold (see e.g. algorithm in FIG. 10), a threshold data set including feature vectors is input in the local model. According to examples of embodiments, the threshold data set comprises only benign samples. As a result, a reconstructed data vector from the local model is obtained. Then, a mean squared error is computed on the basis of the threshold data set and the reconstructed data vector.

Next, a quantile value of the computed mean squared error is computed (e.g. Q₉₀). Furthermore, a mean and a standard deviation of the computed mean squared error are calculated.

Then, it is determined whether the quantile value of the mean squared error is greater than a value which is based on a sum of the calculated mean of the mean squared error and the standard deviation of the mean squared error. For example, the value which based on a sum of the calculated mean of the mean squared error and the standard deviation of the mean squared error is a sum of the calculated mean of the mean squared error and k times the standard deviation of the mean squared error, wherein k is a natural number equal to or greater than 3.

In case the determination is affirmative, the sum of the calculated mean of the mean squared error and the standard deviation of the mean squared error is used as the fourth threshold. Otherwise, the computed quantile value is used as the fourth threshold.

Next, when the fourth threshold is obtained, in S730, a local testing procedure for the local model by using the computed fourth threshold is executed.

When executing the local testing procedure for the local model using the computed fourth threshold, a reconstruction error (in FIG. 3, eₖ) for predetermined test data on the local model is computed. Then, it is determined whether the computed reconstruction error is equal to or greater than the fourth threshold. When the determination results in that the computed reconstruction error is equal to or greater than the fourth threshold, it is decided that a result of the local testing procedure is abnormal.

In S740, it is decided whether the local model is shared with an FL server providing the global model, or the training procedure of the local model is to be repeated.

It is to be noted that according to some examples of embodiments, in the local testing, a performance matrix for at least one of an accuracy, a precision, a recall and an F1 score of the local model is computed.

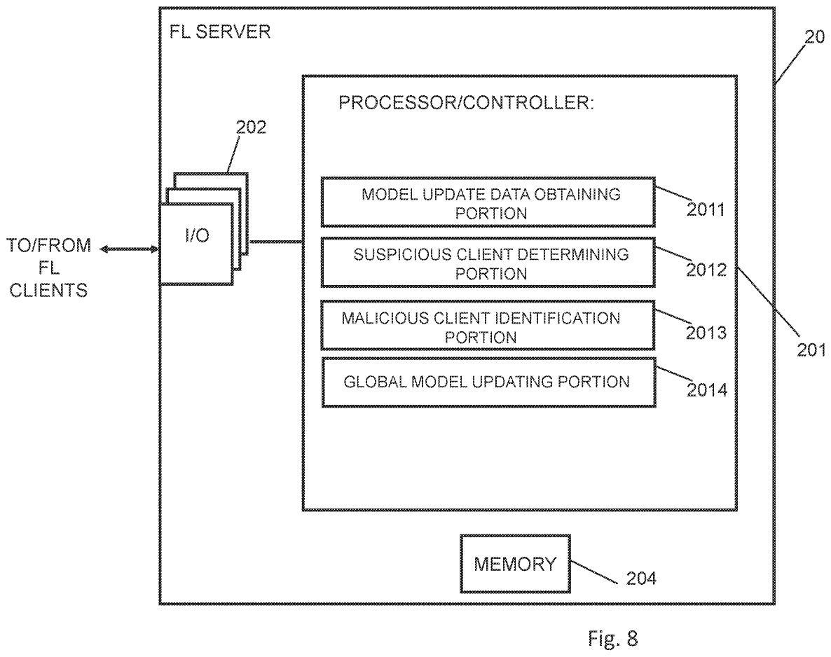

FIG. 8 shows a diagram of a network element or network function acting as an FL server 20, which conducts a control procedure according to some examples of the embodiments, as described in connection with FIGS. 3 and 4. It is to be noted that the network element or function such as the FL server 20 may include further elements or functions besides those described herein below. Furthermore, even though reference is made to a network element or function, the element or function may be also another device or function having a similar task, such as a chipset, a chip, a module, an application etc., which can also be part of a network element or attached as a separate element to a network element, or the like. It should be understood that each block and any combination thereof may be implemented by various means or their combinations, such as hardware, software, firmware, one or more processors and/or circuitry.

The FL server 20 shown in FIG. 8 may include a processing circuitry, a processing function, a control unit or a processor 201, such as a CPU or the like, which is suitable for executing instructions given by programs or the like related to the control procedure. The processor 201 may include one or more processing portions or functions dedicated to specific processing as described below, or the processing may be run in a single processor or processing function. Portions for executing such specific processing may be also provided as discrete elements or within one or more further processors, processing functions or processing portions, such as in one physical processor like a CPU or in one or more physical or virtual entities, for example. Reference sign 202 denotes input/output (I/O) units or functions (interfaces) connected to the processor or processing function 201. The I/O units 202 may be used for communicating with one or more FL clients. The I/O units 202 may be combined units including communication equipment towards several entities, or may include a distributed structure with a plurality of different interfaces for different entities. Reference sign 204 denotes a memory usable, for example, for storing data and programs to be executed by the processor or processing function 201 and/or as a working storage of the processor or processing function 201. It is to be noted that the memory 204 may be implemented by using one or more memory portions of the same or different type of memory.

The processor or processing function 201 is configured to execute processing related to the above described control procedure. In particular, the processor or processing circuitry or function 201 includes one or more of the following sub-portions. Sub-portion 2011 is a processing portion which is usable as a portion for obtaining model update data. The portion 2011 may be configured to perform processing according to S610 of FIG. 6. Furthermore, the processor or processing circuitry or function 201 may include a sub-portion 2012 usable as a portion for determining suspicious clients. The portion 2012 may be configured to perform a processing according to S620 of FIG. 6. In addition, the processor or processing circuitry or function 201 may include a sub-portion 2013 usable as a portion for identifying a malicious client. The portion 2013 may be configured to perform a processing according to S630 of FIG. 6. In addition, the processor or processing circuitry or function 201 may include a sub-portion 2014 usable as a portion for updating a global model. The portion 2014 may be configured to perform a processing according to S640 of FIG. 6.

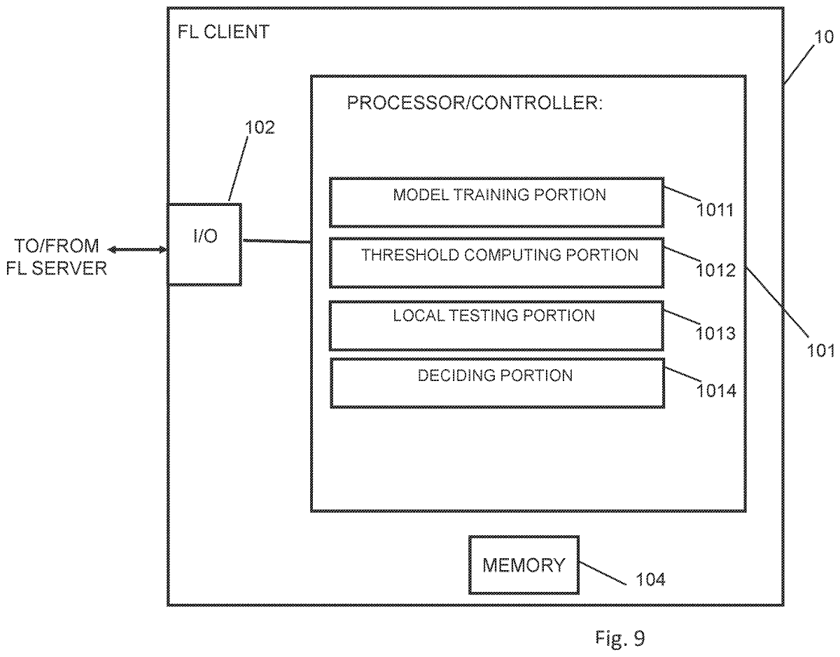

FIG. 9 shows a diagram of a network element or network function acting as an FL client, such as FL client 10, which conducts a control procedure according to some examples of the embodiments, as described in connection with FIGS. 3 and 4. It is to be noted that the network element or function such as the FL client 10 may include further elements or functions besides those described herein below. Furthermore, even though reference is made to a network element or function, the element or function may be also another device or function having a similar task, such as a chipset, a chip, a module, an application etc., which can also be part of a network element or attached as a separate element to a network element, or the like. It should be understood that each block and any combination thereof may be implemented by various means or their combinations, such as hardware, software, firmware, one or more processors and/or circuitry.

The FL client 10 shown in FIG. 9 may include a processing circuitry, a processing function, a control unit or a processor 101, such as a CPU or the like, which is suitable for executing instructions given by programs or the like related to the control procedure. The processor 101 may include one or more processing portions or functions dedicated to specific processing as described below, or the processing may be run in a single processor or processing function. Portions for executing such specific processing may be also provided as discrete elements or within one or more further processors, processing functions or processing portions, such as in one physical processor like a CPU or in one or more physical or virtual entities, for example. Reference sign 102 denotes input/output (I/O) units or functions (interfaces) connected to the processor or processing function 101. The I/O units 102 may be used for communicating with an FL server. The I/O units 102 may be combined units including communication equipment towards several entities, or may include a distributed structure with a plurality of different interfaces for different entities. Reference sign 104 denotes a memory usable, for example, for storing data and programs to be executed by the processor or processing function 101 and/or as a working storage of the processor or processing function 101. It is to be noted that the memory 104 may be implemented by using one or more memory portions of the same or different type of memory.

The processor or processing function 101 is configured to execute processing related to the above described control procedure. In particular, the processor or processing circuitry or function 101 includes one or more of the following sub-portions. Sub-portion 1011 is a processing portion which is usable as a portion for training a model. The portion 1011 may be configured to perform processing according to S710 of FIG. 7. Furthermore, the processor or processing circuitry or function 101 may include a sub-portion 1012 usable as a portion for computing a threshold. The portion 1012 may be configured to perform a processing according to S720 of FIG. 7. In addition, the processor or processing circuitry or function 101 may include a sub-portion 1013 usable as a portion for conducting a local test. The portion 1013 may be configured to perform a processing according to S730 of FIG. 7. Moreover, the processor or processing circuitry or function 101 may include a sub-portion 1014 usable as a deciding portion. The portion 1014 may be configured to perform a processing according to S740 of FIG. 7.

It is to be noted that examples of embodiments are applicable to various different network configurations. The examples of embodiments shown in the above described figures, which are used as a basis for the examples of embodiments described herein, are only illustrative and are not limiting in any way. That is, additional further existing and proposed new functionalities available in a corresponding operation environment may be used in connection with examples of embodiments based on the principles defined.

According to a further example of embodiments, there is provided, for example, an apparatus comprising means configured to obtain local model update data from each of a plurality of clients of a federated learning, FL, procedure, means configured to determine whether at least one of the plurality of clients is a suspicious client showing a harmful behavior in the FL procedure by conducting a test with a reference dataset, if at least one suspicious client is determined, means configured to execute an identification procedure for identifying at least one malicious client, and means configured to perform a global model update process considering a result of a malicious client identification.

Furthermore, according to some other examples of embodiments, the above defined apparatus may further comprise means for conducting at least one of the processing defined in the above described methods, for example a method according to that described in connection with FIG. 6.

According to a further example of embodiments, there is provided, for example, an apparatus comprising means configured to conduct a training procedure for a local model based on a global model received in a federated learning, FL, procedure, means configured to compute a fourth threshold to be used in a test of the local model, means configured to execute a local testing procedure for the local model using the computed fourth threshold, and means configured to decide on sharing the local model with an FL server providing the global model, or to repeat the training procedure of the local model.

Furthermore, according to some other examples of embodiments, the above defined apparatus may further comprise means for conducting at least one of the processing defined in the above described methods, for example a method according to that described in connection with FIG. 7.

According to a further example of embodiments, there is provided, for example, a non-transitory computer readable medium comprising program instructions for causing an apparatus to perform, a processing comprising obtaining local model update data from each of a plurality of clients of a federated learning, FL, procedure, determining whether at least one of the plurality of clients is a suspicious client showing a harmful behavior in the FL procedure by conducting a test with a reference dataset, if at least one suspicious client is determined, executing an identification procedure for identifying at least one malicious client, and performing a global model update process considering a result of a malicious client identification.

According to a further example of embodiments, there is provided, for example, a non-transitory computer readable medium comprising program instructions for causing an apparatus to perform a processing comprising conducting a training procedure for a local model based on a global model received in a federated learning, FL, procedure, computing a fourth threshold to be used in a test of the local model, executing a local testing procedure for the local model using the computed fourth threshold, and deciding on sharing the local model with an FL server providing the global model, or repeating the training procedure of the local model.

It should be appreciated that
an access technology via which traffic is transferred to and from an entity in the communication network may be any suitable present or future technology, such as WLAN (Wireless Local Access Network), WiMAX (Worldwide Interoperability for Microwave Access), LTE, LTE-A, 5G, Bluetooth, Infrared, and the like may be used; additionally, embodiments may also apply wired technologies, e.g. IP based access technologies like cable networks or fixed lines;
embodiments suitable to be implemented as software code or portions of it and being run using a processor or processing function are software code independent and can be specified using any known or future developed programming language, such as a high-level programming language, such as objective-C, C, C++, C #, Java, Python, Javascript, other scripting languages etc., or a low-level programming language, such as a machine language, or an assembler;
implementation of embodiments is hardware independent and may be implemented using any known or future developed hardware technology or any hybrids of these, such as a microprocessor or CPU (Central Processing Unit), MOS (Metal Oxide Semiconductor), CMOS (Complementary MOS), BiMOS (Bipolar MOS), BICMOS (Bipolar CMOS), ECL (Emitter Coupled Logic), and/or TTL (Transistor-Transistor Logic);
embodiments may be implemented as individual devices, apparatuses, units, means or functions, or in a distributed fashion, for example, one or more processors or processing functions may be used or shared in the processing, or one or more processing sections or processing portions may be used and shared in the processing, wherein one physical processor or more than one physical processor may be used for implementing one or more processing portions dedicated to specific processing as described;
an apparatus may be implemented by a semiconductor chip, a chipset, or a (hardware) module including such chip or chipset;
embodiments may also be implemented as any combination of hardware and software, such as ASIC (Application Specific IC (Integrated Circuit)) components, FPGA (Field-programmable Gate Arrays) or CPLD (Complex Programmable Logic Device) components or DSP (Digital Signal Processor) components;
embodiments may also be implemented as computer program products, including a computer usable medium having a computer readable program code embodied therein, the computer readable program code adapted to execute a process as described in embodiments, wherein the computer usable medium may be a non-transitory medium.

Although the present disclosure has been described herein before with reference to particular embodiments thereof, the present disclosure is not limited thereto and various modifications can be made thereto.

### Technical Clauses

Clause 1. An apparatus comprising
at least one processor, and
at least one memory for storing instructions that, when executed by the at least one processor, cause the apparatus at least:
   to obtain local model update data from each of a plurality of clients of a federated learning, FL, procedure,
   to determine whether at least one of the plurality of clients is a suspicious client showing a harmful behavior in the FL procedure by conducting a test with a reference dataset,
   if at least one suspicious client is determined, to execute an identification procedure for identifying at least one malicious client, and
   to perform a global model update process considering a result of a malicious client identification.

Clause 2. An apparatus according to clause 1, wherein model data are based on using, at each client, an autoencoder comprising a predetermined number of encoders and a predetermined number of decoders.

Clause 3. The apparatus according to clause 1 or 2, wherein the instructions, when executed by the at least one processor, cause the apparatus at least
to determine whether at least one of the plurality of clients is a suspicious client showing a harmful behavior in the FL procedure by tracking changes in model related parameters of each of the plurality of clients,
if at least one suspicious client is determined, to conduct a test for each suspicious client with the reference dataset and to determine on the basis of the test whether at least one of the suspicious clients is a confirmed suspicious client,
if at least one confirmed suspicious client is determined, for identifying the at least one malicious client, to execute a statistic check for each confirmed suspicious client and to determine on the basis of the statistic check whether at least one of the confirmed suspicious clients is a malicious client.

Clause 4. The apparatus according to clause 3, wherein the instructions, when executed by the at least one processor, cause the apparatus at least
for determining whether at least one of the plurality of clients is a suspicious client, to cluster local model parameters of each of the plurality of clients,
to compute a cluster centroid for each of the plurality of clients,
to detect for each of the plurality of clients whether a change of the cluster centroid is greater than a first threshold, and
to add, in case the change of the cluster centroid is greater than the first threshold, the corresponding client to a candidate list of suspicious clients.

Clause 5. The apparatus according to any of clauses 3 and 4, wherein the instructions, when executed by the at least one processor, cause the apparatus at least
for determining whether a suspicious client is a confirmed suspicious client, to run the model obtained from the suspicious client on the reference dataset,
to obtain a performance matrix on the basis of a result of running the obtained model,
to compare the obtained performance matrix with a previously obtained performance matrix of a previous iteration update for determining whether a change in the performance matrix is greater than a second threshold, and
to add, in case the change in the performance matrix is greater than the second threshold, the corresponding suspicious client to a candidate list of confirmed suspicious clients.

Clause 6. The apparatus according to clause 5, wherein the instructions, when executed by the at least one processor, cause the apparatus at least
to remove, in case the change in the performance matrix is not greater than the second threshold, the corresponding suspicious client from the candidate list of suspicious clients.

Clause 7. The apparatus according to any of clauses 3 to 5, wherein the instructions, when executed by the at least one processor, cause the apparatus at least
for determining whether a confirmed suspicious client is a malicious client, to compute a mean of a processing layer of the model obtained from the confirmed suspicious client,
to compare the computed mean with a mean of a corresponding processing layer of another client for determining whether a deviation between the means is greater than a third threshold, and
to identify, in case the deviation is greater than the third threshold, the corresponding client as a malicious client.

Clause 8. The apparatus according to clause 7, wherein the instructions, when executed by the at least one processor, cause the apparatus at least
to compute an Euclidian distance between the computed mean of the confirmed suspicious client and the mean of the corresponding processing layer of the other client, and
to determine whether the computed Euclidian distance is greater than the third threshold for identifying whether the confirmed suspicious client is a malicious client.

Clause 9. The apparatus according to clause 7 or 8, wherein the other client is a predetermined client verified to be a normal client.

Clause 10. The apparatus according to any of clams 7 to 9, wherein the processing layer is the last encoded layer of an autoencoder used in the client to be considered.

Clause 11. The apparatus according to any of clauses 3 to 10, wherein the instructions, when executed by the at least one processor, cause the apparatus at least
to exclude each malicious client from the FL procedure, and/or
to inform each client being identified as being malicious about the result of the identification.

Clause 12. The apparatus according to clause 1 or 2, wherein the instructions, when executed by the at least one processor, cause the apparatus at least
to determine whether at least one of the plurality of clients is a suspicious client showing a harmful behavior in the FL procedure by conducting the test with the reference dataset on an aggregated model based on the obtained local model update data from each of a plurality of clients,
to compare a result of the test with a result of a previously conducted test of a previous global model using the reference dataset,
if the comparison shows that at least one malicious client is present, for identifying the at least one malicious client, to determine Euclidian distances of weight parameters of each local model and the global model,
to group the determined Euclidian distances in two groups on the basis of the value of the respective Euclidian distance, and
to identify clients as malicious clients on the basis of the result of the grouping.

Clause 13. The apparatus according to clause 12, wherein the instructions, when executed by the at least one processor, cause the apparatus at least
to consider, for obtaining the aggregated model based on the obtained local model update data from each of a plurality of clients, a priority factor assigned to each of the plurality of clients.

Clause 14. The apparatus according to clause 12 or 13, wherein the instructions, when executed by the at least one processor, cause the apparatus at least
to use, when an iteration of the FL procedure for the aggregated model to be tested is n, a global model for the test using the reference dataset of an (n−1)th iteration of the FL procedure.

Clause 15. The apparatus according to any of clauses 12 to 14, wherein the instructions, when executed by the at least one processor, cause the apparatus at least
to determine, as the a result of the test, a number of false inferences of the test of the aggregated model and a number of false inferences of the previously conducted test of the previous global model using the reference dataset,
to compare a difference of the determined numbers of false inferences with a sixth threshold,
if the comparison shows that the difference of the determined numbers of false inferences is greater than the sixth threshold, to decide that at least one malicious client is present.

Clause 16. The apparatus according to clause 15, wherein the instructions, when executed by the at least one processor, cause the apparatus at least
if the comparison shows that the difference of the determined numbers of false inferences is smaller than or equal to the sixth threshold, to use the aggregated model as a new updated global model.

Clause 17. The apparatus according to clause 15 or 16, wherein the sixth threshold is configurable by a user.

Clause 18. The apparatus according to any of clauses 12 to 17, wherein the instructions, when executed by the at least one processor, cause the apparatus at least
for identifying the at least one malicious client, to determine Euclidian distances of weight parameters of each layer of the local model and each layer of the global model, wherein, when grouping the determined Euclidian distances in two groups, values of the respective Euclidian distance related to one of the layers of the local model and the global model or values of the respective Euclidian distance related to all layers of the local model and the global model are considered.

Clause 19. The apparatus according to any of clauses 12 to 18, wherein the instructions, when executed by the at least one processor, cause the apparatus at least
to identify the clients belonging to the group having the lower cardinality as being malicious clients.

Clause 20. The apparatus according to any of clauses 12 to 19, wherein the instructions, when executed by the at least one processor, cause the apparatus at least
when a malicious client is identified, to obtain a new aggregated model based on the obtained local model update data from each of a plurality of clients excluding the malicious clients,
to conduct the test with the reference dataset on the new aggregated model,
to compare a result of the test on the new aggregated model with the result of the previously conducted test of the previous global model using the reference dataset, and
to verify that no malicious client is present on the basis of the comparison.

Clause 21. The apparatus according to any of clauses 12 to 20, wherein the instructions, when executed by the at least one processor, cause the apparatus at least
when a malicious client is identified, to inform each client being identified as being malicious about the result of the identification.

Clause 22. The apparatus according to any of clauses 1 to 21, wherein the instructions, when executed by the at least one processor, cause the apparatus at least
to discard, when performing the global model update process considering the result of a malicious client identification, model parameter input from the malicious client and
to share an updated model in the next iteration with the plurality of clients involved in the FL procedure excluding the malicious clients.

Clause 23. The apparatus according to any of clauses 1 to 22, wherein the instructions, when executed by the at least one processor, cause the apparatus at least
to conduct the determination of suspicious clients in each iteration of the FL procedure.

Clause 24. An apparatus comprising
at least one processor, and
at least one memory for storing instructions that, when executed by the at least one processor, cause the apparatus at least:
   to conduct a training procedure for a local model based on a global model received in a federated learning, FL, procedure,
   to compute a fourth threshold to be used in a test of the local model,
   to execute a local testing procedure for the local model using the computed fourth threshold, and
   to decide on sharing the local model with an FL server providing the global model, or to repeat the training procedure of the local model.

Clause 25. The apparatus according to clause 24, wherein the instructions, when executed by the at least one processor, cause the apparatus at least
for computing the fourth threshold, to compute a mean squared error in the local model by using a preset validation dataset,
to calculate a mean and a standard deviation of the computed mean squared error,
to determine whether the calculated mean of the mean squared error is smaller than the standard deviation of the mean squared error by a fifth threshold or more,
if the determination is affirmative, to use a first procedure for obtaining the fourth threshold, or otherwise use a second procedure for obtaining the fourth threshold.

Clause 26. The apparatus according to clause 25, wherein the first procedure for obtaining the fourth threshold comprises a quantile thresholding mechanism, and the second procedure for obtaining the fourth threshold comprises a calculation of the fourth threshold by adding the calculated mean of the mean squared error and the standard deviation of the mean squared error.

Clause 27. The apparatus according to clause 24, wherein the instructions, when executed by the at least one processor, cause the apparatus at least
for computing the fourth threshold, to input a threshold data set including feature vectors in the local model, the threshold data set comprising only benign samples, and to get a reconstructed data vector from the local model,
to compute a mean squared error on the basis of the threshold data set and the reconstructed data vector,
to compute a quantile value of the computed mean squared error,
to calculate a mean and a standard deviation of the computed mean squared error,
to determine whether the quantile value of the mean squared error is greater than a value based on a sum of the calculated mean of the mean squared error and the standard deviation of the mean squared error, and
if the determination is affirmative, to use the sum of the calculated mean of the mean squared error and the standard deviation of the mean squared error as the fourth threshold, or otherwise to use the computed quantile value as the fourth threshold.

Clause 28. The apparatus according to clause 27, wherein the value based on a sum of the calculated mean of the mean squared error and the standard deviation of the mean squared error is a sum of the calculated mean of the mean squared error and k times the standard deviation of the mean squared error, wherein k is a natural number equal to or greater than 3.

Clause 29. The apparatus according to any of clauses 24 to 28, wherein the instructions, when executed by the at least one processor, cause the apparatus at least
when executing the local testing procedure for the local model using the computed fourth threshold, to compute a reconstruction error for predetermined test data on the local model,
to determine whether the computed reconstruction error is equal to or greater than the fourth threshold, and
to decide whether a result of the local testing procedure is abnormal when the determination results in that the computed reconstruction error is equal to or greater than the fourth threshold.

Clause 30. The apparatus according to any of clauses 24 to 29, wherein the instructions, when executed by the at least one processor, cause the apparatus at least
to compute a performance matrix for at least one of an accuracy, a precision, a recall and an F1 score of the local model.

Clause 31. The apparatus according to any of clauses clause 24 to 30, wherein local model uses an autoencoder comprising a predetermined number of encoders and a predetermined number of decoders.

Clause 32. A method comprising
obtaining local model update data from each of a plurality of clients of a federated learning, FL, procedure,
determining whether at least one of the plurality of clients is a suspicious client showing a harmful behavior in the FL procedure by conducting a test with a reference dataset,
if at least one suspicious client is determined, executing an identification procedure for identifying at least one malicious client, and
performing a global model update process considering a result of a malicious client identification.

Clause 33. A method according to clause 32, wherein model data are based on using, at each client, an autoencoder comprising a predetermined number of encoders and a predetermined number of decoders.

Clause 34. The method according to clause 32 or 33, further comprising
determining whether at least one of the plurality of clients is a suspicious client showing a harmful behavior in the FL procedure by tracking changes in model related parameters of each of the plurality of clients,
if at least one suspicious client is determined, conducting a test for each suspicious client with the reference dataset and to determine on the basis of the test whether at least one of the suspicious clients is a confirmed suspicious client,
if at least one confirmed suspicious client is determined, for identifying the at least one malicious client, executing a statistic check for each confirmed suspicious client and to determine on the basis of the statistic check whether at least one of the confirmed suspicious clients is a malicious client.

Clause 35. The method according to clause 34, further comprising
for determining whether at least one of the plurality of clients is a suspicious client, clustering local model parameters of each of the plurality of clients,
computing a cluster centroid for each of the plurality of clients,
detecting for each of the plurality of clients whether a change of the cluster centroid is greater than a first threshold, and
adding, in case the change of the cluster centroid is greater than the first threshold, the corresponding client to a candidate list of suspicious clients.

Clause 36. The method according to any of clauses 34 and 35, further comprising
for determining whether a suspicious client is a confirmed suspicious client, running the model obtained from the suspicious client on the reference dataset,
obtaining a performance matrix on the basis of a result of running the obtained model,
comparing the obtained performance matrix with a previously obtained performance matrix of a previous iteration update for determining whether a change in the performance matrix is greater than a second threshold, and
adding, in case the change in the performance matrix is greater than the second threshold, the corresponding suspicious client to a candidate list of confirmed suspicious clients.

Clause 37. The method according to clause 36, further comprising
removing, in case the change in the performance matrix is not greater than the second threshold, the corresponding suspicious client from the candidate list of suspicious clients.

Clause 38. The method according to any of clauses 34 to 36, further comprising
for determining whether a confirmed suspicious client is a malicious client, computing a mean of a processing layer of the model obtained from the confirmed suspicious client,
comparing the computed mean with a mean of a corresponding processing layer of another client for determining whether a deviation between the means is greater than a third threshold, and
identifying, in case the deviation is greater than the third threshold, the corresponding client as a malicious client.

Clause 39. The method according to clause 38, further comprising
computing an Euclidian distance between the computed mean of the confirmed suspicious client and the mean of the corresponding processing layer of the other client, and
determining whether the computed Euclidian distance is greater than the third threshold for identifying whether the confirmed suspicious client is a malicious client.

Clause 40. The method according to clause 38 or 39, wherein the other client is a predetermined client verified to be a normal client.

Clause 41. The method according to any of clams 38 to 40, wherein the processing layer is the last encoded layer of an autoencoder used in the client to be considered.

Clause 42. The method according to any of clauses 34 to 41, wherein the instructions, when executed by the at least one processor, cause the apparatus at least
excluding each malicious client from the FL procedure, and/or
informing each client being identified as being malicious about the result of the identification.

Clause 43. The method according to clause 32 or 33, further comprising
determining whether at least one of the plurality of clients is a suspicious client showing a harmful behavior in the FL procedure by conducting the test with the reference dataset on an aggregated model based on the obtained local model update data from each of a plurality of clients,
comparing a result of the test with a result of a previously conducted test of a previous global model using the reference dataset,
if the comparison shows that at least one malicious client is present, for identifying the at least one malicious client, determining Euclidian distances of weight parameters of each local model and the global model,
grouping the determined Euclidian distances in two groups on the basis of the value of the respective Euclidian distance, and
identifying clients as malicious clients on the basis of the result of the grouping.

Clause 44. The method according to clause 43, further comprising further comprising
considering, for obtaining the aggregated model based on the obtained local model update data from each of a plurality of clients, a priority factor assigned to each of the plurality of clients.

Clause 45. The method according to clause 43 or 44, further comprising
using, when an iteration of the FL procedure for the aggregated model to be tested is n, a global model for the test using the reference dataset of an (n−1)th iteration of the FL procedure.

Clause 46. The method according to any of clauses 43 to 45, further comprising
determining, as the a result of the test, a number of false inferences of the test of the aggregated model and a number of false inferences of the previously conducted test of the previous global model using the reference dataset,
comparing a difference of the determined numbers of false inferences with a sixth threshold,
if the comparison shows that the difference of the determined numbers of false inferences is greater than the sixth threshold, deciding that at least one malicious client is present.

Clause 47. The method according to clause 46, wherein the instructions, when executed by the at least one processor, cause the apparatus at least
if the comparison shows that the difference of the determined numbers of false inferences is smaller than or equal to the sixth threshold, using the aggregated model as a new updated global model.

Clause 48. The method according to clause 46 or 47, wherein the sixth threshold is configurable by a user.

Clause 49. The method according to any of clauses 43 to 48, further comprising
for identifying the at least one malicious client, determining Euclidian distances of weight parameters of each layer of the local model and each layer of the global model, wherein, when grouping the determined Euclidian distances in two groups, values of the respective Euclidian distance related to one of the layers of the local model and the global model or values of the respective Euclidian distance related to all layers of the local model and the global model are considered.

Clause 50. The method according to any of clauses 43 to 49, further comprising
to identify the clients belonging to the group having the lower cardinality as being malicious clients.

Clause 51. The method according to any of clauses 43 to 50, further comprising
when a malicious client is identified, obtaining a new aggregated model based on the obtained local model update data from each of a plurality of clients excluding the malicious clients,
conducting the test with the reference dataset on the new aggregated model,
comparing a result of the test on the new aggregated model with the result of the previously conducted test of the previous global model using the reference dataset, and
verifying that no malicious client is present on the basis of the comparison.

Clause 52. The method according to any of clauses 43 to 51, further comprising
when a malicious client is identified, informing each client being identified as being malicious about the result of the identification.

Clause 53. The method according to any of clauses 32 to 52, further comprising
discarding, when performing the global model update process considering the result of a malicious client identification, model parameter input from the malicious client and
sharing an updated model in the next iteration with the plurality of clients involved in the FL procedure excluding the malicious clients.

Clause 54. The method according to any of clauses 32 to 53, further comprising
conducting the determination of suspicious clients in each iteration of the FL procedure.

Clause 55. A method comprising
conducting a training procedure for a local model based on a global model received in a federated learning, FL, procedure,
computing a fourth threshold to be used in a test of the local model,
executing a local testing procedure for the local model using the computed fourth threshold, and
deciding on sharing the local model with an FL server providing the global model, or repeating the training procedure of the local model.

Clause 56. The method according to clause 55, further comprising
for computing the fourth threshold, computing a mean squared error in the local model by using a preset validation dataset,
calculating a mean and a standard deviation of the computed mean squared error,
determining whether the calculated mean of the mean squared error is smaller than the standard deviation of the mean squared error by a fifth threshold or more,
if the determination is affirmative, using a first procedure for obtaining the fourth threshold, or otherwise use a second procedure for obtaining the fourth threshold.

Clause 57. The method according to clause 56, wherein the first procedure for obtaining the fourth threshold comprises a quantile thresholding mechanism, and the second procedure for obtaining the fourth threshold comprises a calculation of the fourth threshold by adding the calculated mean of the mean squared error and the standard deviation of the mean squared error.

Clause 58. The method according to clause 55, further comprising
for computing the fourth threshold, inputting a threshold data set including feature vectors in the local model, the threshold data set comprising only benign samples, and to get a reconstructed data vector from the local model,
computing a mean squared error on the basis of the threshold data set and the reconstructed data vector,
computing a quantile value of the computed mean squared error,
calculating a mean and a standard deviation of the computed mean squared error,
determining whether the quantile value of the mean squared error is greater than a value based on a sum of the calculated mean of the mean squared error and the standard deviation of the mean squared error, and
if the determination is affirmative, using the sum of the calculated mean of the mean squared error and the standard deviation of the mean squared error as the fourth threshold, or otherwise using the computed quantile value as the fourth threshold.

Clause 59. The method according to clause 58, wherein the value based on a sum of the calculated mean of the mean squared error and the standard deviation of the mean squared error is a sum of the calculated mean of the mean squared error and k times the standard deviation of the mean squared error, wherein k is a natural number equal to or greater than 3.

Clause 60. The method according to any of clauses 55 to 59, further comprising
when executing the local testing procedure for the local model using the computed fourth threshold, computing a reconstruction error for predetermined test data on the local model,
determining whether the computed reconstruction error is equal to or greater than the fourth threshold, and
deciding whether a result of the local testing procedure is abnormal when the determination results in that the computed reconstruction error is equal to or greater than the fourth threshold.

Clause 61. The method according to any of clauses 55 to 60, further comprising
computing a performance matrix for at least one of an accuracy, a precision, a recall and an F1 score of the local model.

Clause 62. The method according to any of clauses 55 to 61, wherein local model uses an autoencoder comprising a predetermined number of encoders and a predetermined number of decoders.

Clause 63. A computer program product for a computer, including software code portions for performing the steps of any of clauses 32 to 54 or any of clauses 55 to 62, when said product is run on the computer.

1-20. (canceled)

21. An apparatus comprising
at least one processor, and
at least one memory for storing instructions that, when executed by the at least one processor, cause the apparatus at least:
to obtain local model update data from each of a plurality of clients of a federated learning, FL, procedure,
to determine whether at least one of the plurality of clients is a suspicious client showing a harmful behavior in the FL procedure by conducting a test with a reference dataset,
if at least one suspicious client is determined, to execute an identification procedure for identifying at least one malicious client, and
to perform a global model update process considering a result of a malicious client identification.

22. The apparatus according to claim 21, wherein model data are based on using, at each client, an autoencoder comprising a predetermined number of encoders and a predetermined number of decoders.

23. The apparatus according to claim 21, wherein the instructions, when executed by the at least one processor, cause the apparatus at least
to determine whether at least one of the plurality of clients is a suspicious client showing a harmful behavior in the FL procedure by tracking changes in model related parameters of each of the plurality of clients,
if at least one suspicious client is determined, to conduct a test for each suspicious client with the reference dataset and to determine on the basis of the test whether at least one of the suspicious clients is a confirmed suspicious client,
if at least one confirmed suspicious client is determined, for identifying the at least one malicious client, to execute a statistic check for each confirmed suspicious client and to determine on the basis of the statistic check whether at least one of the confirmed suspicious clients is a malicious client.

24. The apparatus according to claim 21, wherein the instructions, when executed by the at least one processor, cause the apparatus at least
to determine whether at least one of the plurality of clients is a suspicious client showing a harmful behavior in the FL procedure by conducting the test with the reference dataset on an aggregated model based on the obtained local model update data from each of a plurality of clients,
to compare a result of the test with a result of a previously conducted test of a previous global model using the reference dataset,
if the comparison shows that at least one malicious client is present, for identifying the at least one malicious client, to determine Euclidian distances of weight parameters of each local model and the global model,
to group the determined Euclidian distances in two groups on the basis of the value of the respective Euclidian distance, and
to identify clients as malicious clients on the basis of the result of the grouping.

25. The apparatus according to claim 21, wherein the instructions, when executed by the at least one processor, cause the apparatus at least
to discard, when performing the global model update process considering the result of a malicious client identification, model parameter input from the malicious client and
to share an updated model in the next iteration with the plurality of clients involved in the FL procedure excluding the malicious clients.

26. The apparatus according to claim 21, wherein the instructions, when executed by the at least one processor, cause the apparatus at least
to conduct the determination of suspicious clients in each iteration of the FL procedure.

27. An apparatus comprising
at least one processor, and
at least one memory for storing instructions that, when executed by the at least one processor, cause the apparatus at least:
to conduct a training procedure for a local model based on a global model received in a federated learning, FL, procedure,
to compute a fourth threshold to be used in a test of the local model,
to execute a local testing procedure for the local model using the computed fourth threshold, and
to decide on sharing the local model with an FL server providing the global model, or to repeat the training procedure of the local model.

28. The apparatus according to claim 27, wherein the instructions, when executed by the at least one processor, cause the apparatus at least
for computing the fourth threshold, to compute a mean squared error in the local model by using a preset validation dataset,
to calculate a mean and a standard deviation of the computed mean squared error,
to determine whether the calculated mean of the mean squared error is smaller than the standard deviation of the mean squared error by a fifth threshold or more,
if the determination is affirmative, to use a first procedure for obtaining the fourth threshold, or otherwise use a second procedure for obtaining the fourth threshold.

29. The apparatus according to claim 27, wherein the instructions, when executed by the at least one processor, cause the apparatus at least
when executing the local testing procedure for the local model using the computed fourth threshold, to compute a reconstruction error for predetermined test data on the local model,
to determine whether the computed reconstruction error is equal to or greater than the fourth threshold, and
to decide whether a result of the local testing procedure is abnormal when the determination results in that the computed reconstruction error is equal to or greater than the fourth threshold.

30. The apparatus according to claim 27, wherein the instructions, when executed by the at least one processor, cause the apparatus at least
to compute a performance matrix for at least one of an accuracy, a precision, a recall and an F1 score of the local model.

31. The apparatus according to claim 27, wherein local model uses an autoencoder comprising a predetermined number of encoders and a predetermined number of decoders.

32. A method comprising
obtaining local model update data from each of a plurality of clients of a federated learning, FL, procedure,
determining whether at least one of the plurality of clients is a suspicious client showing a harmful behavior in the FL procedure by conducting a test with a reference dataset,
if at least one suspicious client is determined, executing an identification procedure for identifying at least one malicious client, and
performing a global model update process considering a result of a malicious client identification.

33. The method according to claim 32, wherein model data are based on using, at each client, an autoencoder comprising a predetermined number of encoders and a predetermined number of decoders.

34. The method according to claim 32, further comprising
determining whether at least one of the plurality of clients is a suspicious client showing a harmful behavior in the FL procedure by tracking changes in model related parameters of each of the plurality of clients,
if at least one suspicious client is determined, conducting a test for each suspicious client with the reference dataset and to determine on the basis of the test whether at least one of the suspicious clients is a confirmed suspicious client,
if at least one confirmed suspicious client is determined, for identifying the at least one malicious client, executing a statistic check for each confirmed suspicious client and to determine on the basis of the statistic check whether at least one of the confirmed suspicious clients is a malicious client.

35. The method according to claim 32, further comprising
discarding, when performing the global model update process considering the result of a malicious client identification, model parameter input from the malicious client and
sharing an updated model in the next iteration with the plurality of clients involved in the FL procedure excluding the malicious clients.

36. The method according to claim 32, further comprising
conducting the determination of suspicious clients in each iteration of the FL procedure.
